(19) United States
(12) Patent Application Publication
(10) Pub. No.: US 2024/0169277 A1
(43) Pub. Date: May 23, 2024

(54) BOOKING SYSTEM FOR GROUP MOVEMENTS

(71) Applicant: SERKO LIMITED, Auckland (NZ)

(72) Inventors: Robert James SHAW, Auckland (NZ); Darrin John GRAFTON, Auckland (NZ)

(21) Appl. No.: 18/430,885

(22) Filed: Feb. 2, 2024

Related U.S. Application Data
(63) Continuation-in-part of application No. 17/211,380, filed on Mar. 24, 2021.
Application No. 17/211,380 is a division of application No. 15/392,378, filed on Dec. 28, 2016, now abandoned.
Application No. 15/392,378 is a division of application No. 14/570,614, filed on Dec. 15, 2014, now abandoned.
Application No. 14/570,614 is a continuation of application No. PCT/NZ2013/000100, filed on Jun. 12, 2013.

(30) Foreign Application Priority Data
Jun. 14, 2012 (NZ) 600619

(51) Int. Cl. G06Q 10/02; G06Q 10/10; G06Q 50/14

(52) U.S. Cl. CPC G06Q 10/02; G06Q 10/025; G06Q 10/10; G06Q 50/14

(57) ABSTRACT

An online booking system caters for the corporate booking of the travel of a number of people to a single destination or multiple destinations by providing a file with details of the trip destination, the desired time of arrival, the people involved and the criteria which override the normal corporate travel criteria. The booking system then merges this with the corporate travel criteria and any external profile criteria of the individuals, searches for suitable flights and makes incomplete bookings for individuals to the destination by connecting to a Global Distribution System (GDS) with multiple threads for parallel bookings. The system reviews the collation of the individual but incomplete bookings and, if they do not meet travel policies cancelling the totality forthwith and starting again. If the collation of the incomplete individual bookings meets travel policies completing the totality of bookings and ticketings.

### STATEMENT OF RELATED CASES

This application is a continuation-in-part of U.S. application Ser. No. 17/211,380 filed Mar. 24, 2021, which is a continuation of U.S. application Ser. No. 15/392,378 filed Dec. 28, 2016, which is a continuation of U.S. application Ser. No. 14/570,614 filed Dec. 15, 2014, which is a continuation of PCT/NZ2013/000100 filed Jun. 12, 2013, which claims the benefit of NZ 600619 filed Jun. 14, 2012, all of the preceding applications being herein expressly incorporated by reference.

### FIELD OF THE INVENTION

The invention relates to a computer system, computer-implemented method, and software product that carries out automated booking of travel and accommodation for a group of individuals travelling on behalf of an organization in accordance with rules established by the organization. The travel bookings may be for any number of travellers, can originate from any origin, usually but not necessarily to a specific destination, and with any number of flights and varying itineraries. Examples of such groups of individuals include but are not limited to sports teams travelling to an away game, and crew movements where a large number of people have to be transported to a mining or logging camp. In both instances, failure to book a flight or other travel mode arriving within a defined time window will result in additional and often very significant costs/penalties to the organization.

### Glossary

“Corporate travel bookings” includes teams as well as groups of employees travelling to meet date/time requirements.

“Crew Movement” refers to a block of persons, such as a mining shift, scheduled to be at a certain destination at a specified time, also known as a “crew rotation”, “swing shift” or “shift plot”. Typically, a crew movement involves the travel of from 300 to 1000 people at one time (though in some case this can involve the movement of several thousand people at the same time), usually to the same destination, and may also include travel of an equal or similar number of people in the opposite direction.

“GB” is a convenient abbreviation for Group Bookings.

“GDS” refers to a Global Distribution Systems booking system and/or a collection of third-party disparate content providers.

“PNR” refers to the Passenger Name Record.

“Profile” refers to the information stored by a travel provider in relation to an individual. Typically, this Profile includes the name, address, preferences for seating and class, etc. The “Passenger Name Record” (PNR) may comprise a subset of the information associated with the Profile not particularized for the organization concerned.

“Policy”: Means the rules set by the organization by which an individual travelling for the organization must abide by if possible. Typically, these rules relate to expense levels or timeliness as required by the organization.

“Selling seats” is the terminology used by GDS to refer to booking seats whether paid for or not.

“Serko Online™” is a trademark of the Applicant, Serko Limited.

“Team Movement” refers to the movement of a sports team, normally (but not limited to) comprising from 20 to 40 people. Team movements to different destinations may occur more frequently than a crew movement for regular away games.

“TMC” refers to a Travel Management Company.

### BACKGROUND OF THE INVENTION

Booking systems exist which interface with either various travel or accommodation organizations or with the native booking systems of such groups such as airlines, vehicle rental companies, or hotel chains.

Most of these booking systems are adequate for booking individuals or families, but typically do not allow for corporate travel bookings where individuals have specific travel or accommodation preferences or rights, such as first-class travel and accommodation, or restricted accommodation costs and the cheapest travel available.

In particular, such conventional booking systems do not allow for what is called a “crew movement,” a “crew rotation,” a “swing shift,” or a “shift plot,” where a block of persons, such as a sporting team or a mining shift, are scheduled to be at a certain destination at a specified time. It is important to ensure the entire crew are delivered on time to a destination, and to do this each person has to be booked individually, which takes time for each booking, together with the risk that the preferred fare class may become unavailable, or the flight is or becomes full such that other flights must be considered.

The first major problem to overcome is to locate the appropriate flight or other travel mode to ensure the group of persons arrives at the destination at the appropriate time. In most cases the desired arrival time or “time window” will be specified by the organization. Arriving too late or too early will increase the organization's costs significantly. If the desired flight is not specified by the organization, then a plurality of different possible flights, modes of travel, stop-overs, accommodations, and/or ground transportation will must be located and assessed to find the best fit for the number of passengers in the group for meeting the time of arrival constraints.

The second major problem is that the time required by the system for securing the bookings is a significant limiting factor. It is important to secure the appropriate class of travel from the travel vendor in the first instance or try, noting that each member of the crew rotation has to be booked individually with the travel vendor (taking a finite amount of time per crew member), and often a flight or fare class on the flight is or becomes booked out before all the crew bookings can be made.

We are faced with a number of different time constraints, including:
the time taken to make a booking of an individual seat,
the time taken to complete all of the bookings required for the number of people in the group wishing to travel together,
the need to ensure that the group is delivered to a destination within the defined time window to allow one crew to land in time to commence the next crew rotation, and also to match this with the outgoing crew so they can be returned to their home base or bases,
the time delay of airline travel schedules not flying multiple or even daily flights,
the time differential being influenced by a weather event due to the wider travel window across multiple flights, multiple days,
flight availability being limited because of the increased time window when airline involuntary cancellations occur
time delays impacting the well-being of individual rotational crew, who need to meet minimum health and safety requirements to operate heavy duty machinery following arrival.

A complication in the process of “selling seats” (i.e., bookings) is that some providers expire sessions within a short timeframe. The execution of large numbers of availability requests is a time-consuming process, and it is possible for availability information to expire prior to booking.

For example, in many cases, airlines provide a limited number of lower-class fares per flight and these tend to be booked out first, thereby increasing the cost of travel to the organization if the lower-class fares are no longer available. As each passenger has to be booked separately, the act of attempting to book seats for a large number of persons is itself time consuming and risks (a) incurring higher fares, or (b) losing the opportunity to book seats on a particular flight as other travellers may be competing for bookings at the same time.

Bookings may involve interacting with global distribution systems (GDS), or with particular airlines or other providers of travel services, e.g., ground transportation or accommodation providers.

Different airlines and different GDSs use different interfaces and often have different requirements and have different outputs making searching and booking different suppliers sites time consuming.

GDS Booking systems in particular provide only limited data on the number of available seats. They use a single character field for the number of remaining available seats, using digits between 0 and 9, where the value 9 indicates there are 9 or more seats available. This single character field makes it difficult for a bulk booking as at the outset as it is not possible to ascertain how many seats are available—just that there are 9 or more seats if the GDS response shows a value of 9.

Another complication is that airline booking systems often return a failure to book or purchase for a number of the travellers and/or bookings, and the ticketing systems provided by some providers causes transaction sessions to expire within a short timeframe, all making it problematic to book for any large number of number of passengers.

In yet a further complication, a particular physical seat in an aircraft can be offered for sale under multiple fare categories, so that when one booking purchases one of those fares, the number of fares available for purchase in each affected fare category is decremented.

Consequently, the principle problems to be solved for providing a booking system capable of effectively and reliably booking travel (and/or accommodation) for a large group of travellers as in a crew movement or a team movement are: (a) how to locate the best flight for the group (if not already specified), and (b) how to secure the appropriate class of travel on a required mode of transport (e.g., an aircraft) for a large number of people travelling at the same time, and (c) how to ensure the crew rotation is delivered at the required time (as each day without the shift or team increases costs for the organization dramatically), and the delivery of one crew at the end of a previous shift frequently overlaps with the exfiltration of the previous crew.

Conventionally, a booking system may be embodied as a web-based travel booking system, operated for example by a Travel Management Company (TMC) which may carry the identities and needs of the persons to travel (name, gender, contact, travel preferences, etc. constituting the Profile of the person or traveller). Such a booking system may interface with software (e.g., API's) or systems of actual travel providers (e.g., the airline, the hotel) with which the persons are to be booked, and/or it may interface with one or more Global Distribution Systems (GDS) such as Amadeus GDS, Travelport/Galileo GDS, Sabre GDS, Apollo GDS, Worldspan GDS, and Abacus GDS, which provide an interface to the booking system for reserving airline seats, hotel rooms, rental cars, and other travel sectors. These GDS's create a booking known as a Passenger Name Record (PNR).

Further, organization for which the travellers are travelling may have preferences which may specify, e.g., for a particular standard operation, the required destination, the time frame for arriving at the destination, the level of travel (first class, business, economy, etc.), and the level of accommodation at the destination or a transfer location. To this may be supplied the identifiers for the passenger records in the booking system.

Thus, conventional booking systems may be expected to adequately address the typical requirements of booking a small number of individuals to their proper destinations within the constraints set by the Profiles of the individuals and any corporate preferences set by the organizations for which the individuals are traveling. Booking on an individual basis for a mining shift, however, is beyond the capability of such conventional systems, because at each shift change the majority of a very large staff changes; managers, drivers, miners, catering staff, pilots, admin staff, recreational staff, and medical staff—all must change.

Hence the booking for example of perhaps several thousand persons in an outback Australia mining shift is a long and involved operation in normal circumstances. Each passenger has to be booked indicvidaully which in itself is time consuming. To look up preferences or limitations imposed by their employer increases the time needed for each booking.

A bulk booking of all such persons is normally not possible by way of conventional booking systems because of differing travel and accommodation criteria, for instance for a shift manager versus a mining face operator, and because, in airline travel, the number of seats needed to be booked may exceed the seats available at a particular price level.

Since the critical number of seats available is not normally known (the problem with booking systems showing only 0-9 seats available as described above), there is a likelihood that for commercial reasons that fares for a bulk number of seats may eventually have some seats costing far more than the cheapest seat available. Additionally, details in a PNR for luggage and intermediate stop preferences may be overridden in the interests of a quicker booking if the speed of the booking system limits the likelihood of being able to complete all bookings.

In addition, it may become necessary for individual PNR requirements, for instance for vegetarian meals or specific class accommodation, to override or be overridden by certain organizational preferences.

The present invention described herein provides a booking system which takes account of such preferences and profiles to provide a form of bulk booking which resolves all conflicts and provides a quicker solution than previously available therefore enhancing the probability of success over previous attempts to book a large number of people concurrently.

### INVENTIVE CONCEPT

The inventive concept is a computer implemented method of booking a travel event for a desired number of individuals in a group, in accordance with an organization's policies (e.g., budgets) and individual preferences (if any) of each member of the group, so that the group arrives at a required destination within a specified time window, by interfacing with one or more vendor ticketing systems and carrying out a plurality of search queries to locate possible flights, assessing the flight or flights best matching the group's criteria, and making individual incomplete bookings via the vendor systems, each booking based on the merger of a bulk file specifying specific elements of the travel event including the destination and the names of the individuals participating in the travel event, the personal Profiles of the individuals, and the organizations policies or rules pertaining to travel.

### SUMMARY OF THE INVENTION

In a first, non-limiting aspect of the invention, there is provided a method of automated bulk travel booking for a plurality of individuals associated with an organization, the method implemented with a booking system comprising computer hardware that includes at least a processor, memory, and communications interface, and software stored on a non-transitory data storage medium readable by the computer hardware and executable by the processor of the computer hardware so as to carry out the method, the method comprising:

storing in the memory of the booking system, first stored information relating to the organization's travel policies;

storing in the memory of the booking system, second stored information relating to details and travel policies of said individuals;

uploading to the booking system and storing, in the memory of the booking system, a bulk file relating to a travel event for the organization, wherein at least a portion of the individuals are indicated as travellers for whom travel is to be arranged for the travel event, the bulk file being segregated by predetermined categories of mandatory information,

the mandatory information including details of each one of said travellers, a destination of each traveller, additional travel policies of the organization, and a date and time window for arrival at the destination,

merging the first stored information, the second stored information, and said additional travel policies of the organization contained in the bulk file, to generate and store a merged prioritised set of rules;

if a flight is specified in the bulk file, then the booking system checks if the flight exists on the day/time specified and if it does, then moving to the booking step;

if the specified flight does not exist on the day/time specified, or if no flight is specified in the bulk file, then the booking system retrieves the date/time window at the destination from the merged prioritised set of rules, and conducts a search for flights which correspond to the date/time window by interfacing with ticketing systems of one or more travel providers, querying for flights to the destination that comply with the date/time window, and selecting the flight most closely matching the date/time window;

as a booking step, the booking system checks via the interface ticketing systems of the one or more travel providers whether the selected flight and available fare levels accords with the organization's polices:

if so, the booking system creates individual bookings in accordance with the merged prioritised set of rules;

if not, the booking system proceeds to the next closest matching flight and repeats the check on the organization's policies and repeats the booking process.

The bulk file may specify flight details. If a flight is specified in the bulk file, then the booking system checks if the flight exists on the day/time specified and if it does, then moving to the booking step;

In a particular embodiment, the search for flights is achieved by spawning a number of search tasks, implemented as processes or threads executable by one or more processors or processor cores more or less in parallel, to simultaneously or semi-simultaneously query the availability of different flights or other travel stages from one or more travel providers.

In a particular embodiment, the available flights are compared with the merged prioritised set of rules to assess if each flight is within policy and meets the date and time window for arrival at the destination.

In a particular embodiment, the bookings are made by spawning a number of booking tasks, implemented as processes or threads and connecting to a Global Distribution System (GDS) such that a travel request for each individual traveller is presented to a GDS booking system as a process thread for booking, and multiple process threads are presented in parallel.

In a particular embodiment, the merged prioritised set of rules resulting from the merging of the first stored information, the second stored information, and the additional travel policies of the organization contained in the bulk file, comprises:
what flight should be taken,
what fare levels are allowable,
what should be booked or marked as waitlisted,
whether interconnecting flights using an overnight stop are allowable,
what level of accommodation is allowed at an overnight stop,
what expenditure allowance is set,
whether minimum fare levels can be overridden and to what extent,
what arranged fares are available, and
what charter helicopter flights may be available from an airport destination.

In a particular embodiment, the booking system stores categories of what information is mandatory, and checks for data completeness by:
retrieving, from the first stored information, the organization travel policies for said group movement;
parsing the bulk file uploaded to the booking system according to the predetermined categories of mandatory information to determine
   a) for each traveller, whether said traveller is an individual whose details and travel policies are stored in the second stored information, and generating an indication for any travellers whose details and travel policies are not so stored, and
   b) whether all mandatory information is present;
if all mandatory information is present in the bulk file, retrieving the mandatory information including the details and travel policies of each one of the travellers, and the additional travel policies of the organization;
if mandatory information is missing from the bulk file, taking remedial action including one or more of:
   querying at least one of the first and second stored information for the missing information,
   requesting input of the missing information, or
   inputting a suggestion for the missing information;
retrieving any further details and travel policies of the travellers from the first and/or second stored information.

In a particular embodiment, the method also includes defining a booking window in which all of the bookings need to be completed, and using the merged prioritised set of rules, individually booking travel for each one of the travellers to the destination in compliance with the merged set of rules in order to complete all of the bookings within the defined time window, and on successful completion, issuing the bookings and outputting the bookings to the organization and/or the individuals.

In another, non-limiting aspect of the invention, there is provided a computer system for automated bulk travel booking for a plurality of individuals associated with an organization, the system comprising:

a server, in communication with an information storage system having stored thereon first stored information including details of organization travel rules, and second stored information including details of the individuals and travel policies of the individuals,

the server having a non-transitory computer-readable data storage with software stored therein, the software, upon execution by the server, configured to cause the server to operate:

as a bulk file parser that reads and operates upon a bulk file uploaded to the server of the booking system,

the bulk file relating to a travel event defining a date/time window for arrival of the plurality of individuals at a destination, wherein at least a portion of the individuals are indicated as travellers for travel to a destination, the bulk file being segregated by predetermined categories of mandatory information regarding each one of said travellers sufficient to create a booking, and additional travel policy properties of the organization;

as a rule merger that merges the first stored information, the second stored information, and the additional travel policy properties of the organization contained in the bulk file to thereby generate and store a merged set of prioritised rules; and

as a flight search tool that interfaces with one or more flight databases to retrieve one or more flights that correspond to the date/time window, and then to select a flight from said retrieved one or more flights most closely matching the date/time window;

a checking tool that checks that the selected flight and available fare levels associated with the selected flight accords with polices of the organization included in the merged set of prioritised rules; and

as a booking tool that interfaces with at least one ticketing system of one or more travel vendors for each one of said travellers to the destination, in accordance with the merged set of rules, and on successful completion to output information of bookings for each traveller to the organization and/or to each of the travellers.

In a particular embodiment, the bulk file parser is configured to parse the bulk file according to the predetermined categories of mandatory information to determine:
a) for each traveller, whether said traveller is an individual whose details and travel policies are stored in the information storage system, wherein the server is configured to indicate any travellers whose details and travel policies are not so stored, and
b) whether all mandatory information is present,

and, where mandatory information is missing, the bulk file parser causes the server to take remedial action including querying the information storage system for one or more of:
the missing information,
requesting input of the missing information, and
inputting a suggestion for the missing information.

In a particular embodiment, the booking system is configured to output the bookings by performing at least one of:
generating at least one of an e-mail or downloadable document listing all the bookings for the travellers, and
generating separate messages or e-mails to each traveller of the travellers with information of booking details of the traveller.

In a particular embodiment, the rule merge overrides one or more of the organization travel rules of the first information with one or more of the additional travel policy properties of the organization contained in the bulk file.

In yet another, non-limiting aspect of the invention, there is provided a method of automated bulk travel booking for a plurality of individuals associated with an organization, the method implemented with a booking system comprising computer hardware that includes at least a processor, memory, and communications interface, and software stored on a non-transitory data storage medium readable by the computer hardware and executable by the processor of the computer hardware so as to carry out the method, the method comprising:

storing, in the memory of the booking system, first stored information relating to organization travel policies;

storing, in the memory of the booking system, second stored information relating to details and travel policies of said individuals;

uploading to the booking system and storing, in the memory of the booking system, a bulk file relating to a travel event for the organization, wherein at least a portion of the individuals are indicated as travellers to a destination common to all the travellers, the bulk file being segregated by predetermined categories of mandatory information;

the mandatory information including details of the organization booking the travel, additional organization travel policies, details of each one of the travellers, the common destination of the travellers, and a time and date at which the travellers are to be at the common destination;

parsing the bulk file uploaded to the booking system according to the predetermined categories of mandatory information to determine
a) for each traveller, whether said traveller is an individual whose details and travel policies are stored in the second stored information, and generating an indication for any travellers whose details and travel policies are not so stored, and
b) whether all mandatory information is present;

if all mandatory information is present in the bulk file, retrieving the mandatory information including the details of the organization booking the travel, the details of the additional organization travel policies, the details of each one of the travellers, the common destination of the travellers, and the time and date at which the travellers are to be at the common destination;

if mandatory information is missing from the bulk file, taking remedial action including one or more of:
querying the stored information for the missing information, requesting input of the missing information, or
inputting a suggestion for the missing information;

retrieving any further details and travel policies of the travellers from one or both of the first stored information and the second stored information;

merging the first stored information, the second stored information, and the additional organization travel policies contained in the bulk file to generate and store a merged prioritised set of rules;

interfacing with ticketing systems of one or more travel providers, and booking travel with said ticketing systems for each one of the travellers to the common destination in compliance with the merged prioritised set of rules; and outputting information of the bookings achieved via said ticketing systems by performing at least one of
generating at least one of an e-mail or downloadable document listing all the bookings for the travellers, and
generating e-mails to each traveller of the travellers with information of booking details of the traveller.

In a particular embodiment, the bulk file further includes details of a location the travellers are travelling from, and a time at which the travellers are to depart.

In a particular embodiment, the bulk file further includes details of a required flight number.

In a particular embodiment, the details of each one of the travellers includes each of a name, an address, and contact information, and also a profile of any special requirements applicable to the travel event.

In a particular embodiment, the retrieval from the bulk file includes details of the location the travellers are travelling from and the time at which the travellers are to depart.

In a particular embodiment, a required flight number is retrieved from the bulk file uploaded to the booking system.

In a particular embodiment, each of the name, the address, and the contact information, as well as the profile of any special requirements applicable to the travel event, are retrieved from the bulk file uploaded to the booking system.

In a particular embodiment, at least some of the individual bookings are conducted in parallel.

In another, non-limiting aspect of the invention, there is provided a method of bulk booking travel for a number of individuals for an organization, the method implemented with a booking system comprising computer hardware that includes at least a processor, memory, and communications interface, and software stored on a non-transitory data storage medium readable by the computer hardware and executable by the processor of the computer hardware so as to carry out the method, the method comprising:

storing in the memory of the booking computer system first information relating to travel policies or rules of the organization;

storing in the memory of the booking computer system second information relating to profile details of individuals;

storing in the memory of the booking computer system a bulk file containing information relating to a travel event for an organization of a number of individuals to a destination, the bulk file including details of an arrival date/time window for the or each destination, the identity of each individual traveller, additional individual traveller travel details relating to this travel and additional travel policies or rule properties of the organization relating to said travel event;

merging the first information, the second information, and the additional travel policies or rule properties of the organization contained in the bulk file to produce a merged prioritised set of rules;

connecting to a Global Distribution System (GDS) and identifying one or more flights from the GDS which most closely matches the arrival date/time window, and then presenting a travel request for each individual traveller to a GDS booking system as a plurality of process threads processed in parallel, for individually produce a booking of travel to the destination for each traveller,

individually checking for errors in the booking of each individual traveller in accordance with the merged prioritised set of rules;

reviewing a collation of the individual bookings and, if the collation of bookings does not meet travel policies (including total cost) cancelling the totality forthwith and

if the collation of the individual bookings does meet travel policies

completing the collation of bookings and ticketing, the booking computer system thus booking the individual travel and issuing the bookings as ticketings.

In a particular embodiment, if the collation of the individual bookings does meet travel policies, carrying out the additional step of cancelling the totality forthwith and re-presenting the totality to the GDS booking system in a threaded manner for booking and ticketing the booking computer system thus booking the individual travel and issuing the bookings as ticketings.

In a particular embodiment, the travel request thread for each individual traveller originates from one of multiple cloud servers, each cloud server being capable of originating multiple threads.

In a particular embodiment, a cloud server thread relating to a travel request is capable of originating multiple other cloud server threads.

In a particular embodiment, when the collation of the individual bookings does not meet travel policies and have been cancelled, retrieving references to any unused ticketings currently held by the organization, originating in cancelled or other ticketings from previous travel, are compared with the flights now booked to see if they can be redeemed as part payment for some of the totality of bookings and if so, the unused ticket is validated with the originator and applied during the ticketing process.

In a particular embodiment, the bulk file includes at least some travel policy properties of at least some individuals, and wherein when the merged policies do not allow a booking to be made for an individual, the entry for the individual in the bulk file is marked as in error and referred for resolution before the booking process continues.

In a particular embodiment, the bulk file may contain conditional values relating to at least some of the time parameters specified for individual travel, the conditional values specifying an allowable variance from the time specified in the bulk file.

In another, non-limiting aspect of the invention, there is provided a travel booking computer system for bulk booking the travel of a number of individuals by an organization, comprising: at least one processor, in communication with at least a data bus, a network interface, and a memory;

non-volatile data storage, in communication with the processor and comprising a non-transitory data storage medium having stored thereon each of first stored including details of organization travel rules, second stored information including details of the individuals and travel policies of the individuals, and executable code that, upon execution by the processor, causes the travel booking computer system to operate as:

a bulk file parser that stores, in the memory, a bulk file including data from the organization, the bulk file including details of a destination and a date and time of arrival of the number of individuals, details of the individuals, and additional travel policy properties of the organization;

a rules merger that merges the first information, the second information, and the additional travel policy properties of the organization contained in the bulk file to generate a merged prioritised set of rules;

a travel booker that communicates, via the network interface, with a travel booking provider in order to:
(a) individually check with the travel booking provider a travel of each of the number of individuals to the destination in compliance with the merged prioritised set of rules; and
(b) booking the checked travel and issuing the booking if found to be in compliance with the merged prioritised set of rules.

In a particular embodiment, the bulk file may contain conditional values relating to at least some of the time parameters specified for individual travel, the conditional values specifying the allowable variance from the time specified in the bulk file.

In a particular embodiment, the online booking system is adapted to corporate booking for travel of a number of people to a single destination or multiple destinations by providing a bulk file that specifies details at least of the destination, the desired time of arrival, the people involved, and the criteria which override the normal corporate travel criteria contained in the first information. The booking system merges the information contained in this bulk file with the first and second information, searches for suitable flights and books individuals to the destination by connecting to a Global Distribution System (GDS) as a travel booking provider, using multiple processor threads for parallel bookings. The system reviews a collation of the individual bookings and, if the bookings do not meet travel policies, the system cancels the totality of the bookings and ticketings forthwith and starts again. If the collation of the individual bookings meets the travel policies, the totality of the bookings and ticketings is carried out.

In yet another, non-limiting aspect of the invention, there is provided a method of bulk booking a travel event for a number of individuals for a corporate body, implemented with a booking system comprising computer hardware that includes at least a processor, memory, and communications interface, and software stored on a non-transitory data storage medium readable by the computer hardware and executable by the processor of the computer hardware so as to carry out the method, the method comprising:

storing in the memory of the booking computer system information relating to travel policies or rules of the corporate body;

storing in the memory of the booking computer system information relating to profile details of individuals;

storing in the memory of the booking computer system a bulk file relating to the travel event for a corporate body of a number of individuals to a destination, the bulk file including
details of each individual traveller,
additional individual traveller travel details relating to the travel event, and
additional travel policies or rule properties of the corporate body relating to the travel event;

merging the first stored information, the second stored information, and that additional organization travel policies contained in the bulk file to generate and store a merged prioritised set of rules;

connecting to a Global Distribution System (GDS), and transmitting to a GDS booking system a travel request for each individual traveller as a process thread for individually booking, individually checking for errors in the booking of each individual traveller to the destination, in accordance with the merged prioritised set of rules;

reviewing the collation of the individual bookings; and

if the bookings do not meet travel policies cancelling a totality of any booking with the GDS booking system,

if the collation of the individual bookings does meet travel policies, cancelling the totality of any booking with the GDS booking system and re-presenting the totality to the GDS booking system in a threaded manner for booking and ticketing the booking computer system thus booking the individual travel and issuing the bookings as ticketings.

In a particular embodiment, the travel request thread for each individual traveller originates from one of multiple cloud servers, each cloud server being capable of originating multiple threads.

In a particular embodiment, a cloud server thread relating to a travel request is capable of originating multiple other cloud server threads.

In a particular embodiment, when the collation of the individual bookings does meet travel policies, cancelling the totality forthwith, retrieving references to any unused ticketings currently held by the organization, originating in cancelled or other ticketings from previous travel, are compared with the flights now booked to see if they can be redeemed as part payment for some of the totality of bookings and if so, the unused ticket is validated with the originator and applied during the ticketing process.

In a particular embodiment, the bulk file includes at least some travel policy properties of at least some individuals, and wherein when the merged policies do not allow a booking to be made for an individual, the entry for the individual in the bulk file is marked as in error and referred for resolution before the booking process continues.

In a particular embodiment, the bulk file may contain conditional values relating to at least some of the time parameters specified for individual travel, the conditional values specifying the allowable variance from the time specified in the bulk file.

In another, non-limiting aspect of the invention, there is provided a travel booking computer system for bulk booking the travel of a number of individuals by an organization, comprising: at least one processor, in communication with at least a data bus, a network interface, and a memory;

non-volatile data storage, in communication with the processor and comprising a non-transitory data storage medium having stored thereon each of first stored including details of organization travel rules, second stored information including details of the individuals and travel policies of the individuals, and executable code that, upon execution by the processor, causes the travel booking computer system to operate as:

a bulk file parser that stores, in the memory, a bulk file including data from the organization;

the bulk file including details of a destination of the number of individuals, details of the individuals sufficient to create a booking, details of any additional individual travel policies and additional corporate travel policies for the travel;

a rules merger that merges the first information, the second information, and the additional travel policy properties of the organization contained in the bulk file to generate a merged prioritised set of rules;

and

a travel booker that communicates, via the network interface, with a travel booking provider in order to:
(a) individually check with the travel booking provider a travel of each of the number of individuals to the destination in compliance with the merged prioritised set of rules; and
(b) booking the checked travel and issuing the booking if found to be in compliance with the merged prioritised set of rules.

In a particular embodiment, the bulk file may contain conditional values relating to at least some of the time parameters specified for individual travel, the conditional values specifying the allowable variance from the time specified in the bulk file.

In a yet further, non-limiting aspect of the invention, there is provided a method of booking travel for a number of individuals for a corporate body by:

providing a booking system,

storing in the booking system information relating to travel policies of the corporate body,

storing in the booking system information relating to the details and travel policies of individuals,

creating a bulk file relating to the travel for a corporate body of a number of individuals to a destination,

the bulk file including details of individual traveller and additional travel policy properties of the corporate body,

creating within the booking system a crew movement action relating to the travel of a number of individuals to a single destination or a variety of destinations,

retrieving from the stored information the corporate body travel policies for that action,

retrieving the details of the individual travellers from the bulk file,

retrieving any further details and travel policies of the individual travellers from the stored information,

merging the corporate body, individual traveller, and bulk file policies,

individually booking each individual traveller to the destination,

issuing the bookings.

In a particular embodiment, the bulk file includes at least some travel policy properties of at least some individuals.

In a particular embodiment, the travel costs are paid at the same time as booking.

In yet another, non-limiting aspect of the invention, there is provided a travel booking system for booking the travel of a number of individuals by a corporate body and having:

an information storage system storing details of the corporate body travel rules,

access to a travel booking provider,

a bulk file parser reading a bulk file provided by the corporate body,

the bulk file including details of the required destination of the number of individuals, details of the individuals sufficient to create a booking,

a travel booker booking individually the travel of each of the number of individuals to the destination in compliance with the corporate body travel rules,

an email issuer issuing emails to individuals successfully booked.

In a particular embodiment, the bulk file includes additional travel rules, and the booking process provides a rule merger merging rules in a specified manner to provide a booking in accord with the merged rules.

Other aspects of the invention are set forth in the claims the contents of which are deemed to be incorporated herein by way of reference.

### BRIEF DESCRIPTION OF THE DRAWINGS

FIG. 1 shows a diagram of the process equipment.

FIG. 2A shows a flow diagram of the basic process of booking travel.

FIG. 2B shows the process flow within the booking process of FIG. 2A item 211

FIGS. 3A and 3B show details of a bulk file shown as a spread sheet.

FIG. 4 shows an entry screen to the Group Booking System.

FIG. 5 shows the initial setup screen for a bulk booking session

FIG. 6 shows a display and edit screen for individuals of a bulk load

FIG. 7 shows the entry screen for the flight membership entry of an individual

FIG. 8 shows the entry screen for details of an individual

FIG. 9 shows the assembled data from a bulk file before booking commences

FIG. 10 shows a flight lookup facility

FIG. 11 shows a cost centre lookup facility

FIG. 12 shows a later view of FIG. 9 after some amendment

FIG. 13 shows the on-screen display as the bookings are made

FIG. 14 shows the bookings which have been made

FIG. 15 shows an email with a spreadsheet attachment of the bookings

FIG. 16 shows the spreadsheet with booking details

FIG. 17 shows a search facility for the bookings

FIG. 18 shows a filtered selection of bookings

FIG. 19A and FIG. 19B show a multi-threaded version of FIG. 2A and part of FIG. 2B in which many booking threads are used.

FIG. 20 shows a process flow for Example 4.

FIG. 21 shows a graph of the relationship of arrival time to score.

FIG. 22 shows a graph of the relationship of cost to score.

FIG. 23 shows a flow chart of flight and fare allocation.

FIG. 24 shows an architectural overview.

FIG. 25 shows a user centric view of process flow.

FIG. 26 shows a process flow for allocating bookings to the relevant cost centre.

### DESCRIPTION OF THE INVENTION

### Example 1

This example presents a non-limiting embodiment to illustrate the Crew Movement functionality of the invention.

The invention provides the ability for data to be pulled from a source such as spread sheet of crew details and for this data to be used in an automated booking process as described herein.

Crew Movements

The number of days for rotations will vary by company and by type of employee. The rotations could be two weeks on, then one week off or eight days on and six days off or any other variation according to individual company requirements. Clients will want to book three to four sequences of rotations in a single bulk load. Booking numbers could vary anywhere from fifty to three hundred or more depending on requirements.

In order to manage the entire process internally, clients want the ability to make and manage changes to all bookings. Particularly important is the ability to make changes post booking so these requests do not have to be sent back to the Travel Management Company (TMC).

Bookings through computerized systems provided by travel vendors need to take place individually (i.e., one at a time) for each one of the individual passengers. This creates a problem in terms of timing and availability when attempting to book airline tickets for large groups for many reasons, such as those outlined as follows.

Fare Types

In general, clients will have negotiated agreements with one or more nominated airlines, for example in Australia they may have an agreement with any of the major carriers.

Any potential client with a travel expenditure exceeding 1.5 M-2 M dollars is eligible for an agreement.

Due to the enormous demand for seats on the common routes (for example, Karratha, Port Hedland, Broome, Exmouth, Newman & Kalgoorlie), none of the major carriers load inventory at the lower cost end of the fares grid. As such, Best Fare of the Day (BFOD) policies are not a feasible cost option, and the best private fare that can be negotiated by the client becomes the BFOD for the client.

For Western Australia, one of the major airlines holds the main market share of negotiated agreements with the target client base. Most agreements will have ‘B’ class and a ‘Y’ class option, with B class at a slightly lower cost. When booking, the first option will be to secure B class, and then Y class if the B class inventory has been sold. Y class will be the only last seat availability class.

Form of Payment

In general, there will be a single credit card form of payment for the majority of travellers on a spreadsheet roster, however ‘Contractors’ (guest travellers) may need to be charged to a different cost centre and/or a different credit card.

Shutdown Movements

Shutdowns are regularly scheduled events for major maintenance work to take place on some part, or all of, (for example) a mine site or offshore facility (e.g., rig or vessel). Shutdowns can occur once or twice a year, either with a significant notice period or could be scheduled urgently in the case of emergency maintenance being required.

Shutdowns can require the movement of up to or sometimes exceeding 1,000 travellers within a 2-7-day period to a single destination.

Contractors feature significantly in shutdown travel requirements as all type of maintenance work (e.g., electrical, mechanical, and geological) is required to be done at the same time to minimize the down time of the mine site or facility.

When booking shutdown travel, there will need to be an identifying field in order to identify which Contractor company each traveller is working with.

Fare Types

Refer to ‘Fare Types’ for Crew Movements (as above).

Form of Payment

In general, there will be a single credit card form of payment for the majority of travellers on a spreadsheet roster, however ‘Contractors’ (guest travellers) may need a to be charged to a different cost centre and/or a different credit card.

Charter Flights

Many companies contract charter flights (either wholly or partially) to move employees to and from site. If charter flights are used, the travel policy logic will generally—be to fully utilize the charter flight seat allocation before booking any scheduled services.

The objective is to allow the loading of the charter flight inventory into the Server to allow the seats to be booked in conjunction with accommodation and transfers (see below) so that the inventory is being managed ‘live’ and all employee end to end travel bookings are consolidated in a single system.

Camp (Onsite) Accommodation Management

Due to the remote locations of many of the sites, potential clients will most likely have built their own accommodation camps. At present many clients are managing the camp accommodation inventory separate to the flight booking process, resulting in an inefficient manual process to ensure travellers have accommodation confirmed and the inefficient use (or non-use) of camp rooms in many circumstances.

This invention allows the loading of the camp accommodation inventory into the server to allow the rooms to be booked in conjunction with flights and transfers (see below) so that the inventory is being managed ‘live’ and all employee end to end travel bookings are consolidated in a single system.

Transfer Management

‘Transfers’ refers to a bus/alternative vehicle transfer that will take the employees from the airport on arrival to the mine site/facility.

The objective is to manage the transfers' inventory in the same way as charter flights and camp accommodation.

Helicopter or Alternative Connecting Services

There is frequently a requirement for travellers to connect from a fixed wing flight to an alternative service in order to arrive onsite. This is particularly relevant to the Oil & Gas industry where travellers are booked on offshore helicopter services to take them to the rig or vessel. This can be accommodated by this invention.

Shift Plot Movements

(Also known as Core Crew Movements, Crew Rotations, FIFO (Fly In Fly Out))

The invention provides the ability for data to be pulled from a source similar to the attached spread sheet example and for this data to be used in an automated booking process via the server.

The number of days for rotations will vary by company and by type of employee. The rotations could be two weeks on, then one week off or eight days on and six days off or any other variation according to individual company requirements. For the example provided by Client, the rotation is two weeks on and one week off.

Clients will want to book three to four sequences of rotations in a single bulk load. Booking numbers could vary anywhere from fifty to three hundred or more depending on requirements.

Clients want to manage the process themselves rather than relying on the TMC, therefore requiring an automated booking process to be enabled via a Server in accordance with the invention.

Bookings need to be carried out on an individual basis for each one of the individual passengers.

Fare Types

In general, Clients will have negotiated agreements with one or more of the major airlines—see above.

Form of Payment

In general, there will be a single credit card form of payment.

### Example 2—Single Thread

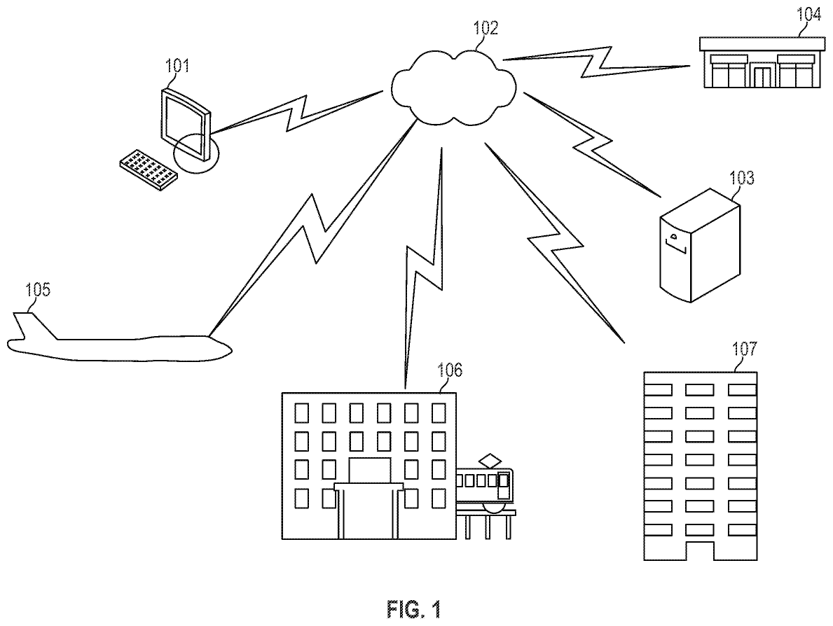

The invention involves the process equipment of FIG. 1 where an operator at a computer screen 101 provides to an online booking tool at server 103 a bulk file containing the relevant details for a bulk booking. This will include:
the corporate body booking the travel,
the destination for the individuals,

at least one of the following:
the time at which they are to depart;
the time at which they are to be at the destination;
the required flight number,
the location they will be travelling from,
each individual's booking details (name, address, contact) and
optionally an individual's profile of any special requirements for this particular travel.

Also stored at server 103 are corporate details of the corporate travel rules, for instance:
the allowed fare levels for various individuals based on their corporate position,
the type of accommodation at any transfer points,
the amount of checked in baggage,
the allowable expenses en-route.

Also included may be details of any travel or accommodation providers who have agreed to special rates, and details of how to get the rates when booking.

Additionally available to the server 103 or stored at the server 103 are the individuals profile details, which may include such things as the individual's airline meal preference and preferred seating position on an aircraft.

The booking tool embodied by the server 103 may be in contact with a Travel Management Company (TMC) 104 which can carry out the actual booking with an airline 105, a rail service 106 or a hotel chain 109 in accord with the rules and preferences, or the booking tool itself may carry out these tasks by communicating directly with services provided by the airline 105, rail service 106, and/or hotel chain 109.

If the group size is relatively small, e.g., a “team movement”, it may be possible to book all of the individuals sequentially but in most cases the group size will be large enough that at least some of the bookings will need to be processed in parallel, as described in Example 3.

The booking tool has provision to define the maximum booking window—the time needed to complete all bookings. This booking window can be used to determine the number of processor threads needed to complete all bookings in parallel. Preferably this booking window may be 1 hour. The number of threads will be proportional to the group size and the size of the booking window.

For example, the required booking window may be 1 hour—so that all bookings need to be completed within this time. This suggested time window is non-limiting as a booking window needs to be different for different types of groups or different GDS or other providers.

The following description refers to a single processor thread and will also help understand how each of the processor threads in Example 2 can work in parallel.

To start the process a bulk file is required for every team movement or crew movement of a shift. This file, which is preferably an XML document, but which may be a spreadsheet or other document format (preferably one which allows for integration with other Workforce management systems and their API's) includes details of:
the corporate body to which it applies,
destination and time details (and may include the actual flight details),
the details of which individuals are to be scheduled to travel and where they are travelling from,
at least their minimal travel details (e.g., name, address, contact number, email, passport number if relevant, PNR or equivalent disparate supplier ID if available),
details of specifics for this travel (e.g., wheelchair required),
corporate travel rules which apply only to this trip (e.g., transfer accommodation must be at a particular hotel chain, air fares cannot exceed a certain figure, the cost centre is “Shift 20211120”).

The bulk file will also include parameters which allow variance in the travel times (for instance the time period before the start of a shift in which the crew may arrive at the destination as a function of the likely delays in an extended travel route). The bulk file is uploaded to the server before the booking process starts.

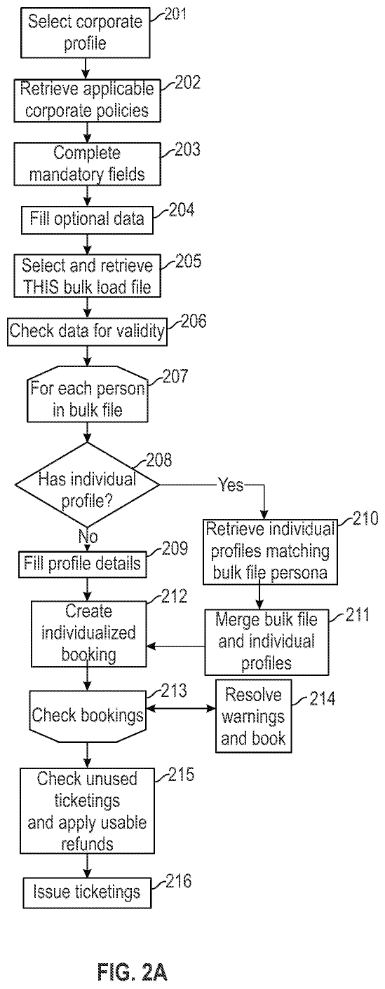

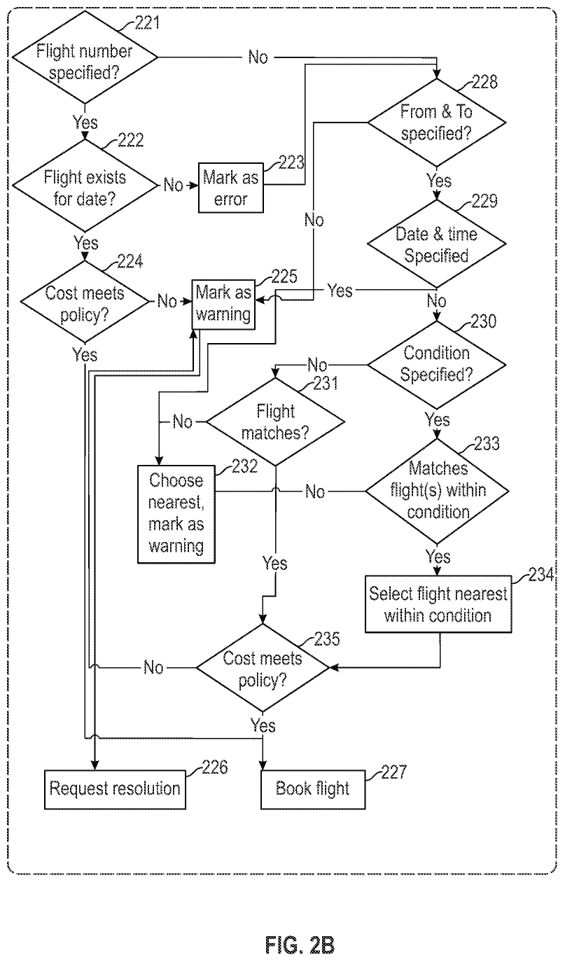

FIG. 2A shows the process of carrying out the booking in which the operator or user at computer 103 first selects the correct corporate profile at 201 (although this may be part of the logging in process required by the booking tool). The system retrieves the applicable corporate policies at 202 and allows the user to fill any mandatory fields such as selecting one policy from the retrieved corporate policies, and a bulk file nominate for loading at 203 before entering any optional fields at 204. The optional fields may include an email or text message facility to advise the user when the lengthy bulk load booking process is completed.

The nominated bulk load file is then retrieved at 205 and parsed in a validity check at 206 so that any missing mandatory information can be entered. The parsing may include retrieving details of an individual from the corporate information if an employee ID is present. Missing information might, for instance, be the details of an individual which were not available when the bulk file was created or the employee ID if this individual is not entered as a contractor. The bulk file may also include an individual traveller's profile ID in some TMC system, and these details also may be retrieved.

Once the mandatory fields have been entered any optional fields may be entered and the system then moves on to loop 207 to book each individual trip.

At 208 the individual entry in the bulk file is checked for a profile or a link to a profile and if one is found it is retrieved at 209. In this case the retrieved profile preferences are merged with the corporate rules in the bulk file and the corporate rules in the corporate file to provide a prioritised set of rules as to:

what flight should be taken,
what fare levels are allowable,
what should be booked or marked as waitlisted,
whether interconnecting flights using an overnight stop are allowable,
what level of accommodation is allowed at an overnight stop,
what expenditure allowance is set,
whether minimum fare levels can be overridden and to what extent,
what arranged fares are available,
what charter helicopter flights may be available from an airport destination and so on.

When these factors all taken into account and any manual input received, an incomplete booking for an individual will be carried out at 212, as this then removes that seat from the number of available; seats for that flight, at least for a short time (depending upon the GDS time out limits).

GDS Booking systems in particular provide only limited data on the number of available seats. They use a single character field for the number of remaining available seats, using digits between 0 and 9, where the value 9 indicates there are 9 or more seats available. This single character field makes it difficult for a bulk booking as at the outset as it is not possible to ascertain how many seats are available—just that there are 9 or more seats if the GDS response shows a value of 9.

Consequently our booking system continues making incomplete bookings on the flight until the GDS returns a value of less than 9 seats available, and our booking system is programmed to compare this value to the number of remaining passengers to be booked. If insufficient seats are available the booking system then searches for another flight.

With a GDS Booking system, when a PNR is created, the seat is removed from the list of available seats on that flight. We realised we could take advantage of this feature by starting a booking but leaving it incomplete. This has the advantage that the seat is removed from the list of available seats so others cannot see it or book it. However, there is a time restraint, typically from 5 to 15 minutes (depending upon the particular booking system) before the GDS booking system will time-out the incomplete booking and release the seat so that is now once again visible as an available seat.

Within that time window, our booking system then moves on to the next booking, make another incomplete PNR, and so on until we have a collection of incomplete bookings, and can check to see if the totality of incomplete bookings matches the customer's policy and price restraints. And if so, we then complete the bookings before they are timed out. If the collection of bookings does not satisfy the policy or time restraints, then those bookings are released. Because our system can handle each booking quickly our system release all incomplete bookings and then quickly rebooks them as complete bookings. This is our preferred mode of operation as our system can then optionally take account of any credits available to that corporate customer when rebooking these seats.

Time is of the essence both in making the incomplete PNR bookings but also in the amount of time/resources used on our server as each Crew Movement consumes considerable computer resources and we endeavour to run multiple crew movement requests for different corporate clients at the same time.

This use of incomplete PNR bookings also allows us to overcome the problem with the GDS Booking systems of limited data on the number of available seats. They use a single character field for the number of remaining available seats, using digits between 0 and 9, where the value 9 indicates there are 9 or more seats available. This single character field makes it difficult for a bulk booking as at the outset it is not possible to ascertain how many seats are available—just that there are 9 or more seats if the GDS response shows a value of 9.

Even so, our system is able to create accurate estimates for Crew Movement Actions based on real fare availability of GDS-sourced flight fares.

As mentioned previously, GDS search responses typically only show between 0 and 9 fares available, where 9 really means 9 or more available. This means that for a given flight the system cannot not know at the outset how many seats are available in total.

With large group bookings of more than 9 travellers, our system creates incomplete PNR records (i.e., provisional bookings) and “sell seats”, but does not finalise the PNR (“sell seats” is the terminology used by the GDS). Effectively, our system has reserved a seat but has not yet confirmed the booking.

This causes subsequent availability checks to be based on a lower availability. Eventually, the availability may fall below the threshold of 9, allowing accurate price and availability information to be determined at which case the PNRs can be cancelled and the inventory released if required.

The following example helps to explain one of the problems our system had to overcome with GDS systems:
Say the objective is to book 15 tickets and there are only 14 available (but the system cannot ascertain this from the GDS response).
If the availability is checked, the GDS will respond with ‘9’ and there is no indication how many more than 9 are available. So, the system starts booking fares one by one . . .
After selling 4, the GDS responds that “9” appear available (where there are actually 10)
After selling 5, the GDS responds that “9” appear available (there are actually 9)
After selling 6, the GDS responds that “8” are available—now our system knows that our system will not be able to sell 9 more to reach 15.

This is why a value less than 9 is useful, as our system can then decide if there are enough available seats in total on that flight to enable to complete a crew movement. This together with our decision to make individual but incomplete bookings at step 212 of FIG. 2 and then to check the collection of incomplete bookings at step 213 before completing the bookings at 215 if they have met all of the requirements of the merged set of rules, enables our system to book a crew movement automatically regardless of the limited information supplied by a GDS on the number of available seats.

Each individual booking is processed as at expanded box 212 in which the passenger and flight details received are resolved into a booking if possible. If a flight number is specified at step 221, then this is checked at 222 to ensure the flight exists on that date, then another check at 224 to ensure that the seat cost will meet the group and individual policies of the cost centre. If it does, then the flight can be booked at 227 and the system moves on to the next flight for that passenger, or else moves on to the next passenger.

Where a flight does not exist at the specified date the entry may be marked as “in error” and may proceed to attempt to book a different flight having the same specified date and time via 228. Where the flight cost is outside policy at 224, then a warning is raised, and the processed data will not be booked but instead marked at 226 for correction and booking after the bulk file is processed.

In the case where no flight number is specified in the bulk file, the departure and arrival locations are checked at 228, with a warning being generated if these are invalid, and the date and time of departure and arrival checked at 229. Again, a warning is generated at 225 if these are absent or in obvious error, but optionally, processing can continue with the first available flight being checked for space, and compliance with policy costs at 230.

A further check at 233 resolves the question of how close to a preferred time a flight must be to allow its selection. The bulk file has a column relating to a “Condition” which may have several different values. Nominally these values are blank, ‘at’, ‘before’, ‘after’ or ‘near’. The policy file may set time values relating to these values. For instance, a particular policy file may specify that a blank may mean that a flight should be within 1 hour of the specified time, an ‘at’ that the flight is within 10 minutes of the time, a ‘near’ within two hours, a ‘before’ within two hours before the specified time and an ‘after’ within two hours after the specified time. These times may vary for individual policies, for group policies, or for enterprise policies, with the most relevant applying. In each case the combination of the specified arrival time and the entry in the “condition” field/column provides an arrival date/time window when searching for suitable flights.

Equally, a weighting given to a departure time versus an arrival time may be weighted differently by different policies.

Given all these criteria the available flights are considered at 234, and the flight most nearly meeting the criteria and closest to any specified time is chosen. A final check that the cost meets the policy requirements is made at 235 allowing a different flight to be tried if too costly, and the flight booked at 227.

The booking system prioritizes the selection of flights by sorting them in order prior to selecting which flight to allocate. The list is in decreasing order of importance, with rule number 1 being the most important:
1. Is within policy.
2. Is within the time window.
3. Meets the time condition.
4. Meets the Via Conditions (the requested connecting flights).
5. Number of stops (to force direct flights to show first).
6 Minimum price (or Base Fare if Price field is invalid/empty/null).
7. Variance for requested times.
8. Total journey time.
9. Line Reference (in the GDS response; in other words, use the ranking which is requested when making the GDS availability call).

Where any warnings were generated, the flight for the individual is not booked, but rather flagged with a warning and marked up with the flight times that most nearly met the available criteria.

Once all bookings are completed the loop ends at 213, any warnings or errors from the booking process resolved at 214, with individual user completion of these. At 215 any references to unused tickets currently held by the organization, originating from cancelled ticketings from previous flights, cancelled flights, or other travel misadventures are compared with the flights now booked to see if they can be redeemed as part payment for some of the new bookings (e.g., same airline) and if so, the unused ticket is validated with the originator and used as the bookings are paid for to create a ticketing. All ticketings are then issued at 215. All bookings are made against a particular corporate cost centre, but the particular centre may vary with the individual concerned even though normally the cost centre specified in the bulk file will prevail.

Individuals will be supplied with the booking details, normally by system email or by SMS or some other messaging service, so that the booking details can be modified directly with the provider if necessary, however it is expected that the individuals will comply with corporate rules.

Where errors or failures occur with the bookings, a system report is provided so that these can be corrected and additionally a confirmation report of each successful booking is provided.

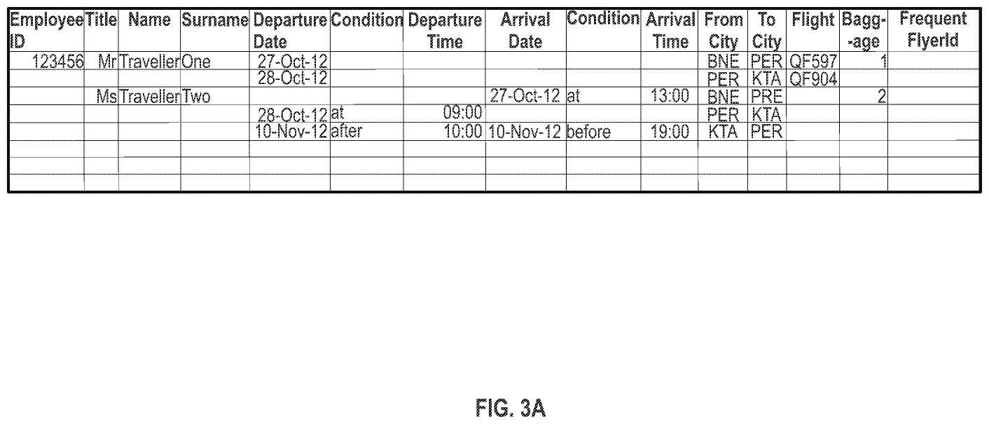

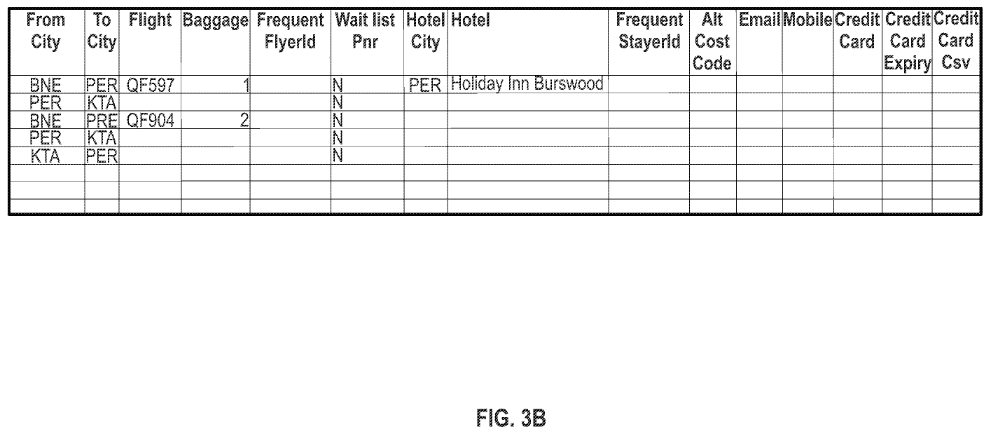

FIG. 3 shows a sample bulk file as two individuals in a spreadsheet (broken into two parts) and showing the employee ID, the surname, first name, title, the departure date and perhaps time of travel, the arrival time date and time, the origin and destination, the preferred flight number, the number of bags, any frequent flyer ID, any preferred hotel for a transfer destination the individuals email and mobile number, credit card number, expiry date and CSV.

Other data may be included, for instance to cover an international flight.

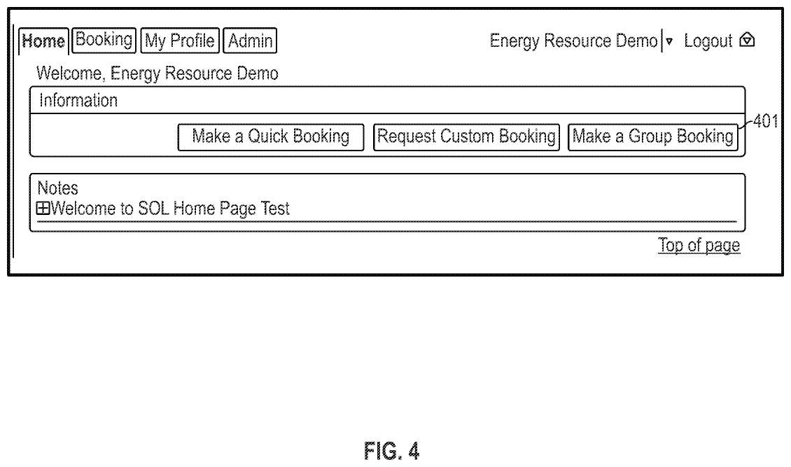

FIGS. 4 through 15 show the process of booking a number of passengers using a bulk file such as that of FIG. 3.

FIG. 4 shows the initial screen of a booking system with an option 401 which allows the creation of a group booking.

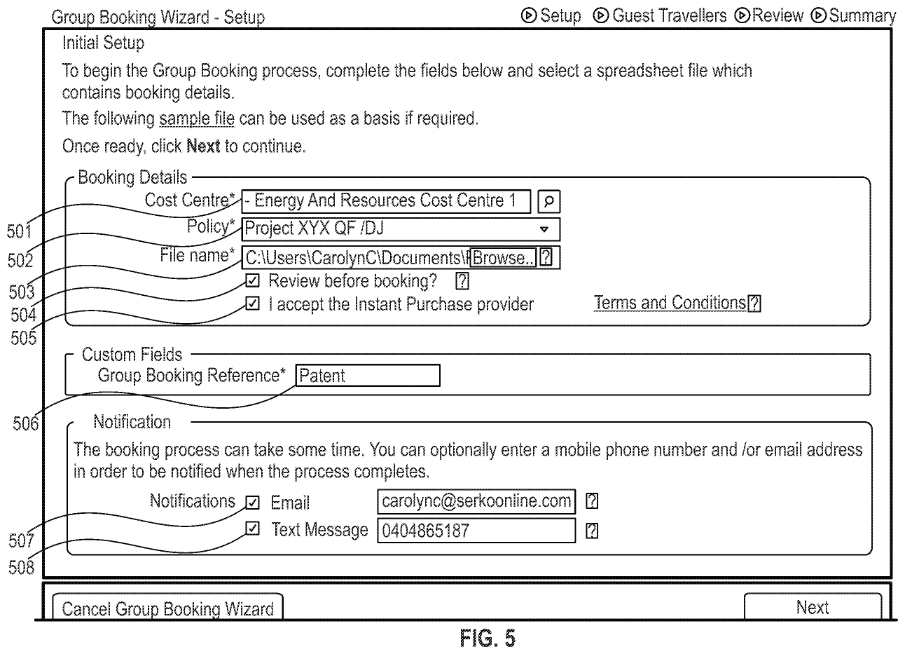

On selection of this option, the screen of FIG. 5 is shown which allows the entry of the accounting cost centre for the group booking at 501, the group policy for the bookings at 502 and the filename of the spreadsheet or other processable document at 503. Other entry fields include options to review the entries before booking at 504, and an acceptance of the Providers terms at 505. Custom fields may be entered at 506 and a call-back option (email and/or mobile) at 507, 508 for the completion of booking may be offered.

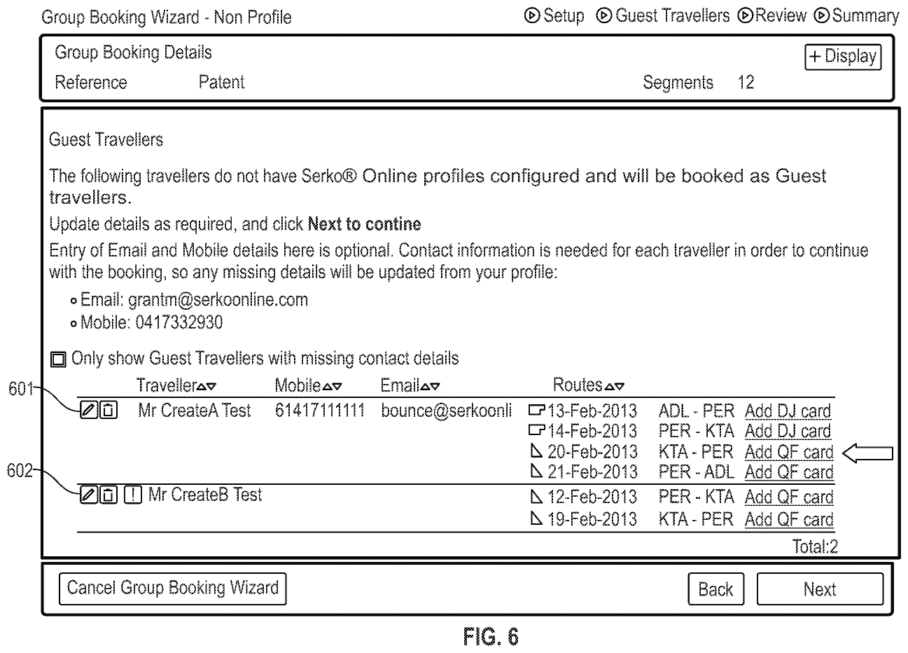

FIG. 6 shows the results of a validation after the bulk file is loaded and the passenger group details are retrieved from it. It differentiates the travellers who are NOT in the profile database, shows what information is present and allows entry of missing detail.

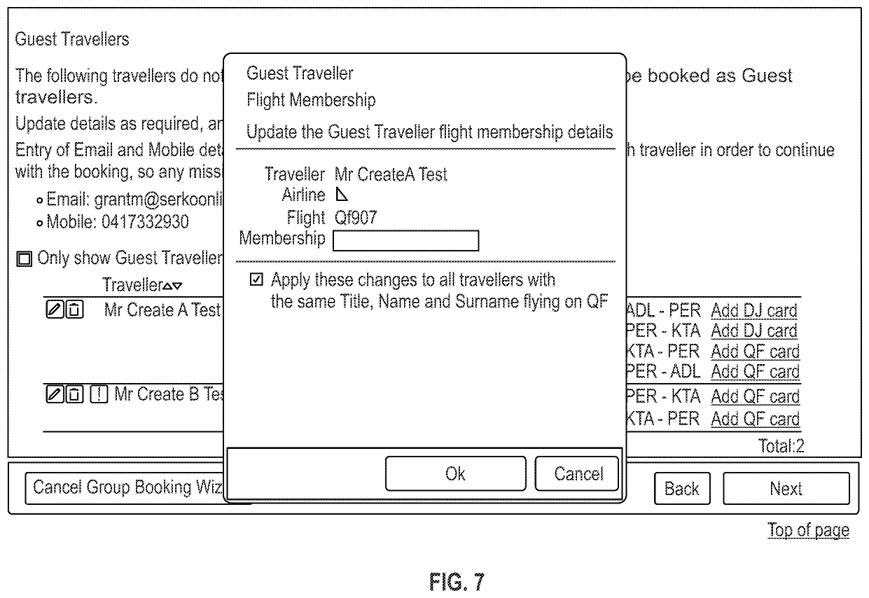

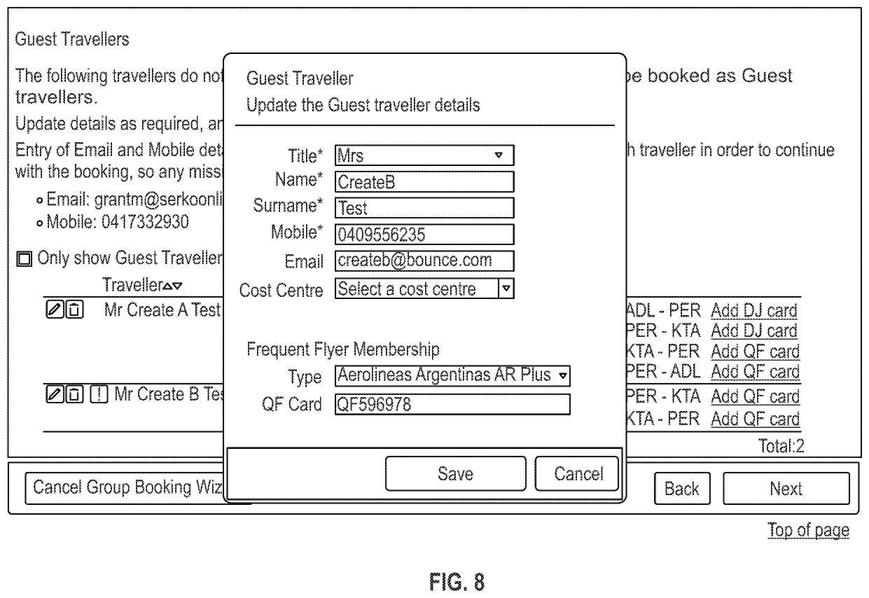

Thus traveller Mr. CreateA Test had mobile number and email details in the bulk file and does not show the warning icon of Mrs. CreateB Test, while Mr. CreateA Test has no frequent flyer details for two of four flights. The missing details from the profile may be added via the Flight Membership entry screen of FIG. 7 or the Guest Traveller details entry screen of FIG. 8.

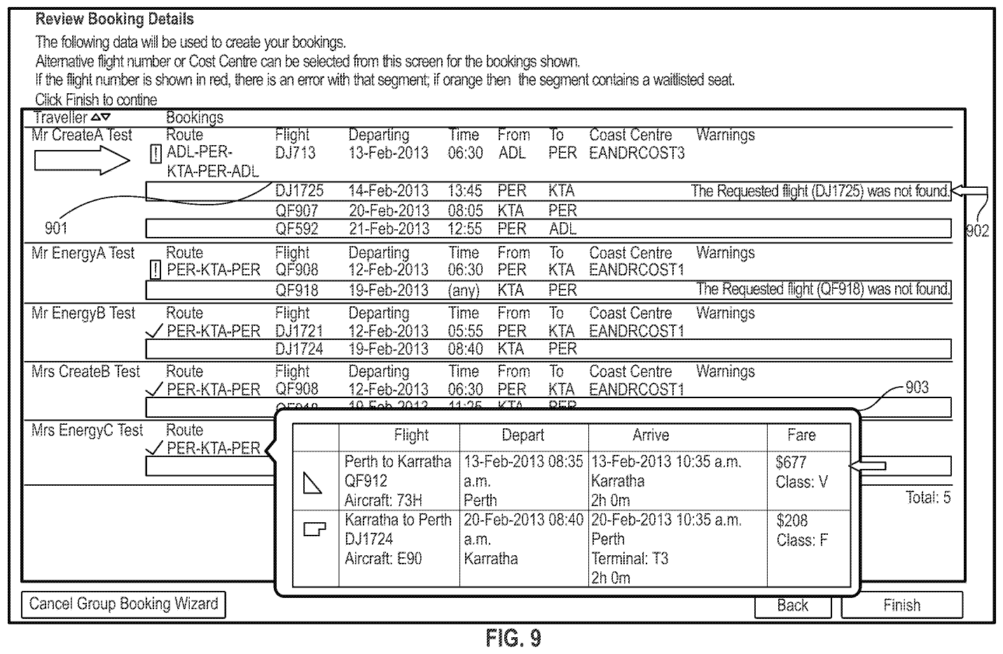

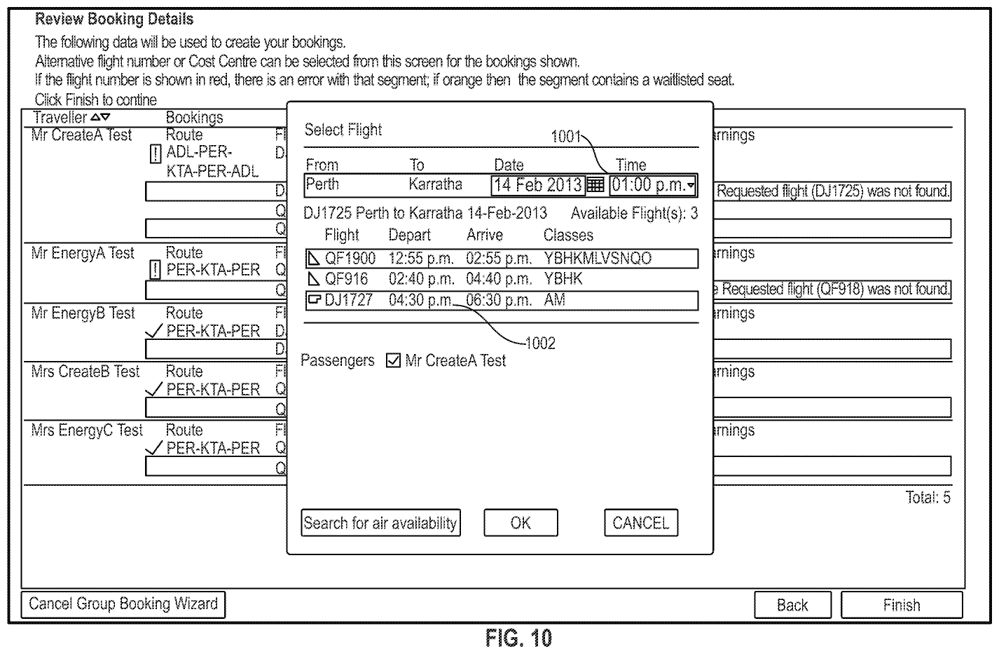

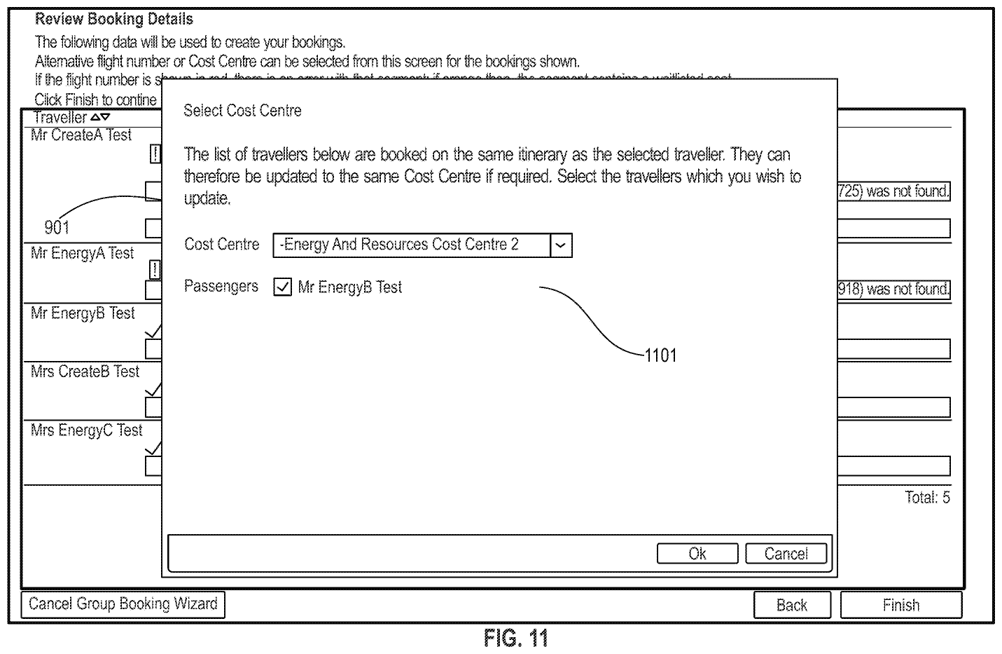

Once all details are entered, the full list from a bulk file as shown at FIG. 9 may be reviewed. As part of the bulk file validation all of the details will have been checked as far as possible without creating bookings, for instance flight numbers will have been verified as to whether the flight exists for the specified date and time, or if no flight number was specified a tentative flight may have been entered from a review of the required date, time and cost centre fare policy applying to the passenger's profile.

Where a specified flight cannot be found, as at errors 901, 902, a selection option 903 available for instance through a mouse hover, may allow choice of an available flight at an equivalent time. Alternatively, the passengers date and time may be altered, and an alternative flight located during processing of the booking which will also meet the fare policy of the passenger. FIG. 10 shows the flight selection screen with over-rideable date and time options 1001 and a selection for the flights found at 1002. FIG. 11 shows the selectable cost centre at 1101 allowing this to be changed if required.

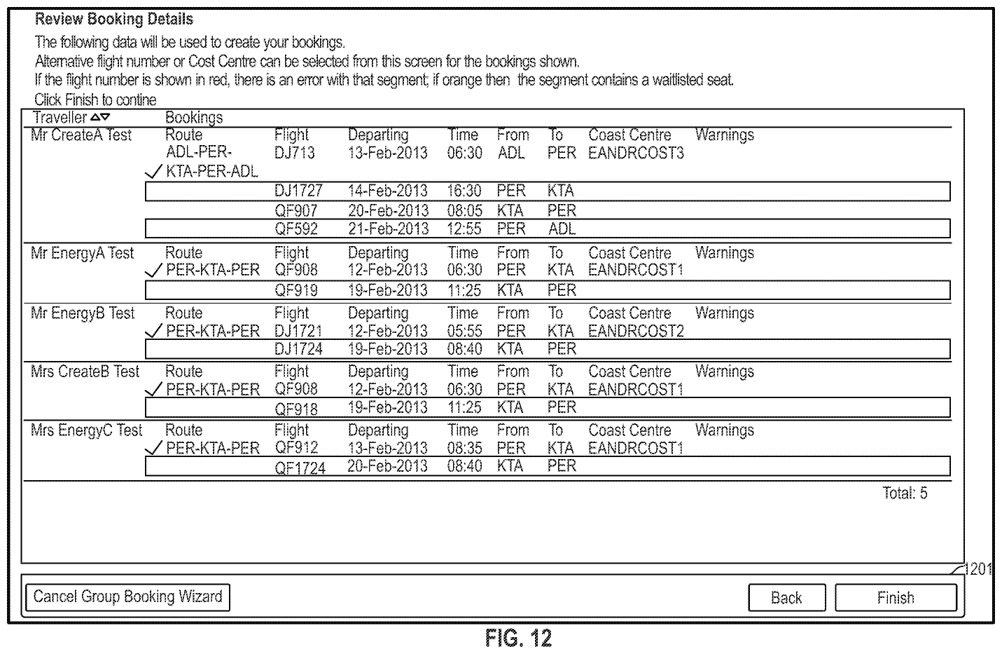

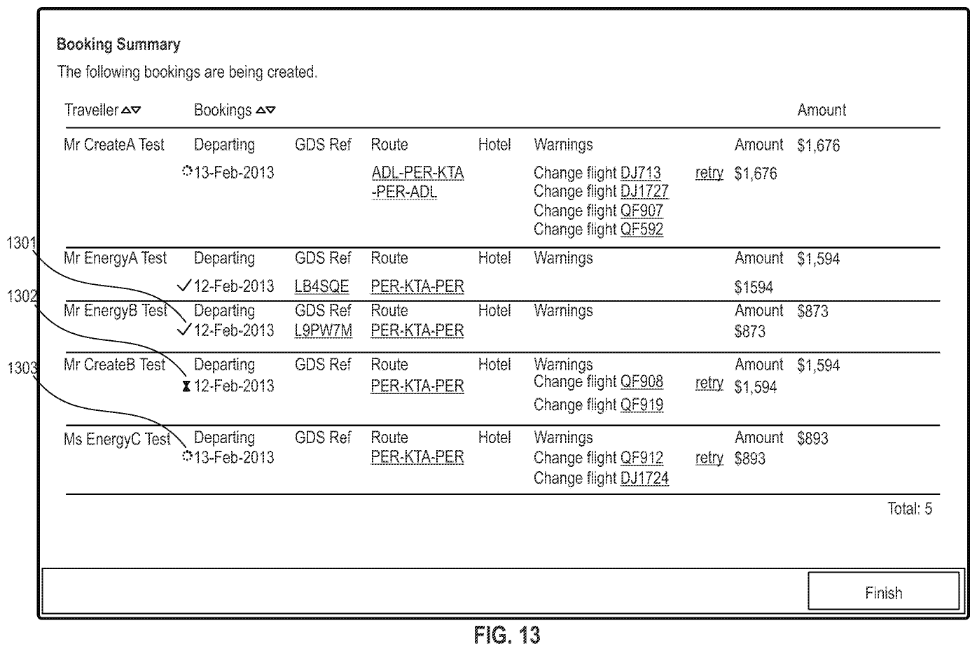

Once all the obvious errors have been corrected, a list clear of errors is displayed as at FIG. 12. Clicking the “Finish” button 1201 initiates the booking process, showing the summary at FIG. 13 while this is occurring. Each passenger and flight may be updated to show the current status of the booking as at 1301, 1302, 1303. Since a bulk booking can take considerable time, the process will be only one window of the multi-window booking processing system.

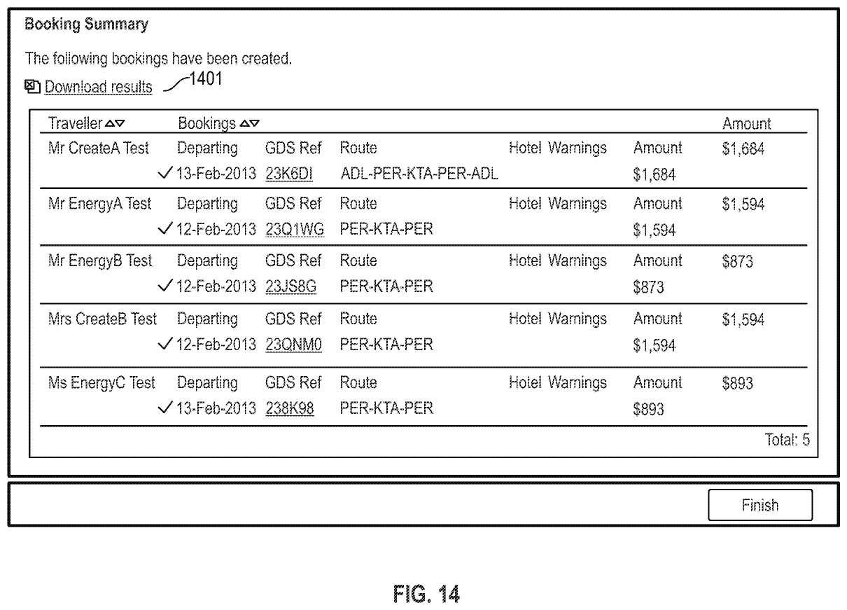

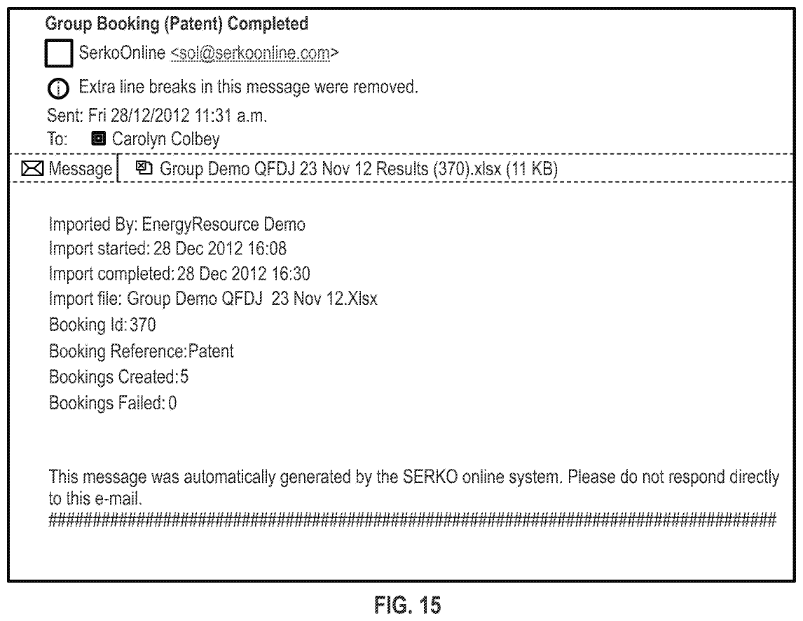

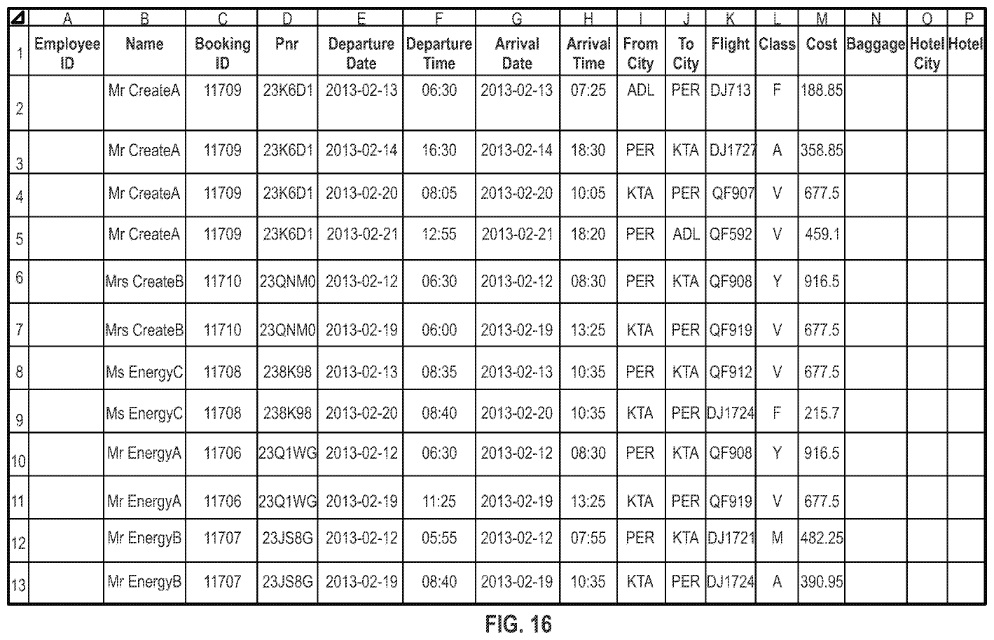

Once the booking process is completed, the completed summary as at FIG. 14 is displayed. An option to download the results at 1401 may result in an email as at FIG. 15 with an attached spreadsheet or similar as shown in FIG. 16 giving details of the passenger, flights, dates, times etc.

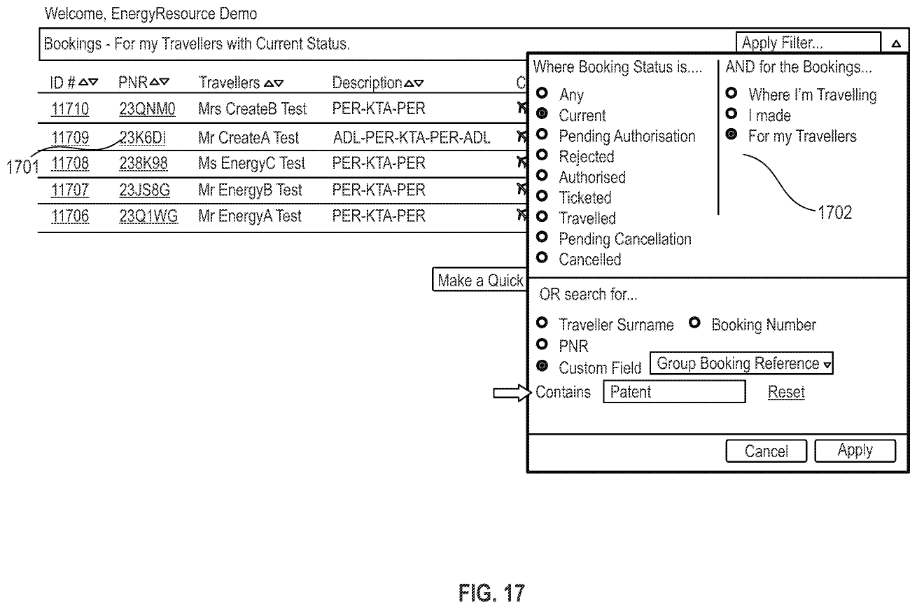

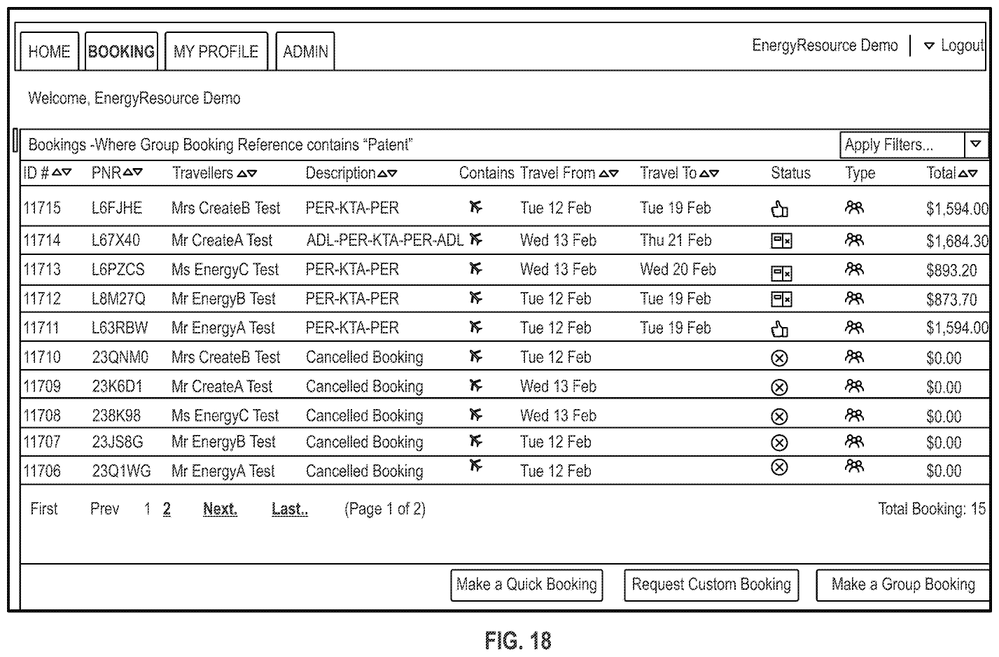

The bookings can now be individually queried or searched, and FIG. 17 shows the results at 1701 of the use of a filter query screen as shown at 1702 while FIG. 18 shows the result of search for the original group booking.

### Example 3—Multi-Threaded Example

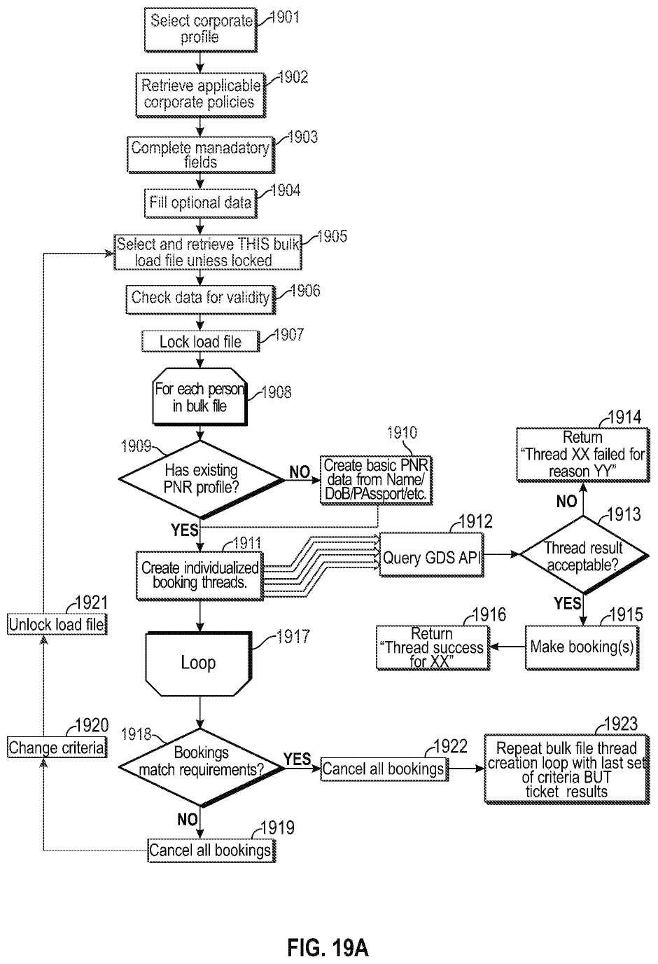

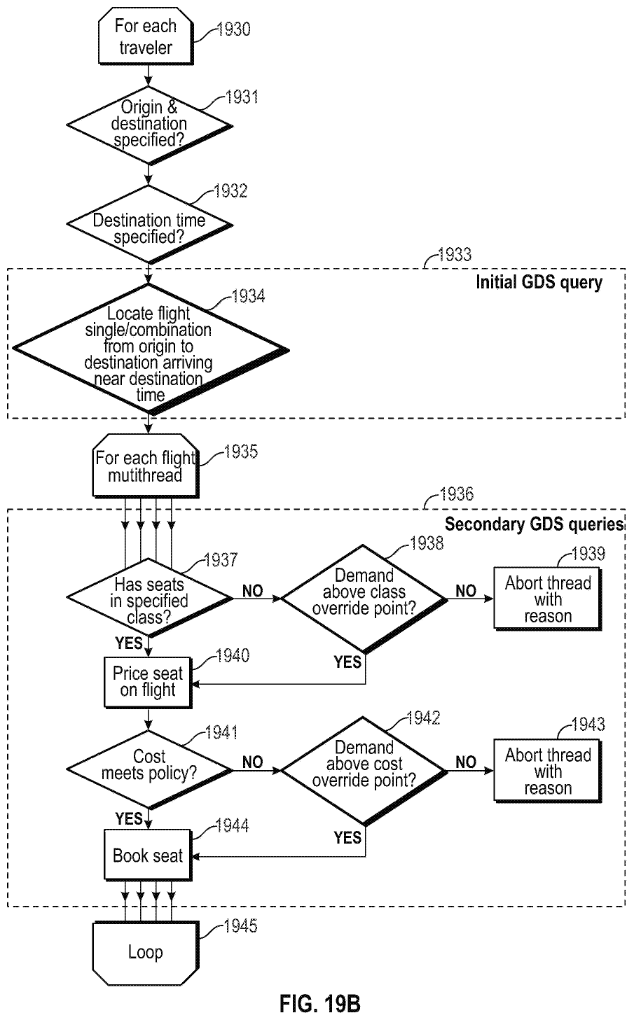

FIGS. 19A and 19B show an example in which the booking process is multi-threaded to enable bookings to be made more quickly and with greater surety that a complete set of bookings will be obtained. This example is to be read in conjunction with Example 2 which explains the features of a single booking thread in more detail. A number of search threads may be spawned to query the availability of different flights or other travel stages and this parallel availability search may take less than a minute to assess availability at the required date/time slots. These threads may then move onto the booking stage, or separate booking threads may be spawned.

Depending on the number of booking threads spawned—some of these threads may book more than one passenger sequentially as per Example 2, though it is preferred that a larger number of booking treads are spawned so that all bookings can be completed in parallel.

FIG. 19A shows the process of carrying out the booking in which the operator at computer 103 first selects the correct corporate profile at 1901 (although this may be part of the logging in process required by the booking tool). The system retrieves the applicable corporate policies at 1902 and allows the user to fill any mandatory fields such as selecting one policy from the retrieved corporate policies, and a bulk file to load at 1903 before entering any optional fields at 1904. The optional fields may include an email or text message facility to advise the user when the lengthy bulk load booking process is completed.

The nominated bulk file nominated by the user to be loaded is then retrieved at 1905 and parsed in a validity check at 1906 so that any missing mandatory information can be entered. The parsing may include retrieving details of an individual from the corporate information if an employee ID is present. Missing information might, for instance, be the details of an individual which were not available when the bulk file was created or the employee ID if this individual is not entered as a contractor. The bulk file may also include an individual traveller's profile ID in some TMC system, and these details also may be retrieved.

Once the mandatory fields have been entered, any optional fields may be entered and the system then moves on to loop 1907 to book each individual trip.

At 1908, the individual entry in the bulk file is checked for a profile or a link to a profile, and if one is found it is retrieved at 1909. In this case, the retrieved profile preferences are merged with the corporate rules in the bulk file. The corporate rules in the corporate file provide a prioritised set of rules as to what flight should be taken, what fare levels are allowable, what should be booked or marked as waitlisted, whether interconnecting flights using an overnight stop are allowable, what level of accommodation is allowed at an overnight stop, what expenditure allowance is set, whether minimum fare levels can be overridden and to what extent, what arranged fares are available, what charter helicopter flights may be available from an airport destination, and so on.

When these factors are all taken into account and any manual input is received, the individual booking will be started as a thread in the overall booking process 1910 in which each thread separately queries a supplier, in this example a GDS API 1911 as explained in more detail in FIG. 19B. To allow this, the thread preferably recreates at least some of the data as a parameter file in a cloud server with details relating to the data in the bulk file for the traveller (such a server may, for instance, run a Semaphore cloud-based automation service in which the parameter file is a yaml file defining pipelines, blocks, and tasks, each of which can be started as a thread on a cloud machine instance). The data parameters may include the options relating to the travellers' personal requirements and the corporate rules. The cloud server queries a GDS for the required flight or flights. This process may result in the cloud server spawning multiple GDS query threads in multiple machine instances, depending on the complexity of the booking. For instance, there may be separate threads for each separate flight, a thread for each airport transfer, plus a thread for any overnight hotel stops.

Any of these threads may fail, in which case the parameter file may allow an alternative parameter to be applied (for instance a higher fare level), and the process will be retried. When all alternatives have been applied without success, the end result is tested at 1912. If the traveller instance has failed, the thread returns a failure response from 1913.

Where the end result is a success, the required bookings are made at 1914 and a thread success flag is returned at 1915 with the data relating to the booking(s).

Once all threads have returned a collated result at 1916, the degree of success of the entire process is evaluated at 1917. Where the entire booking process has produced at least one failure, the process at 1918 may A) cancel all the bookings made so far and B) make changes in one or more of the booking criteria at 1919 before the whole booking process is repeated.

Where the entire booking process has succeeded, the collation of bookings made so far can be approved, ticketed, and stored and individual bookings are notified to each traveller.

In particularly preferred embodiment, an extra step takes place to allow for various credits, or e.g., other arrangements between the client the travel supplier. In this preferred case, where a booking process which meets the eventual bulk file criteria has completed and a reviewer has accepted the tentative bookings, the current bookings are cancelled and the process run again, this time proceeding through the ticketing stages and including the option to use the funds from any cancelled tickets meeting the requirements (correct airline, correct traveller, etc.).

In this preferred arrangement where the entire booking process has succeeded, the collation of bookings made so far are cancelled at 1920 and the entire process repeated as soon as possible at 1921 with the last set of criteria in the expectation that the whole process should provide a successful outcome. With the release of the previously booked results and the changes in the criteria so far made in the parameter files there should be a high probability that the entire result will succeed, and the resultant bookings can be ticketed.

The system allows disparate types of Supplier searches (in this case for air travel), e.g., 3 GDS's, direct API airline, scheduled v. charter airline, and NOC airline connection. In each case, the system provides for Multi-channels in EACH supplier. This allows the system to make a ‘Booking’ decision based on the collective results. This is impossible for a manual consultant to undertake, especially when time is considered.

But the system allows for the same approach for other types of travel requirements including Accommodation, Transfers/Rail/Coaches.

FIG. 19B describes the process occurring at a cloud server in a single received thread in more detail and is essentially equivalent to FIG. 2 step 212 modified for multi-thread demands. The parameter file for this aspect of the travel for each traveller is received at 1930 and the traveller origin and destination confirmed at 1931 together with the time the traveller should be at the final destination at 1932. One or more threads are created at 1934 to locate all possible flight combinations available from the GDS. This will place the traveller at the destination within a bulk file governed timespan matching the traveller time of exit from the final airport.

Each thread enters a sequence loop at point 1935 and queries the GDS in a secondary process 1936 for a seat in the specified class of the first found flight. Because there are many threads already running from other instances of this and other travellers in the same bulk file, there is a likelihood that seats within the maximum price parameters in the parameter file may be fully booked. This occurs because the cost of a seat is dependent on the number of unbooked seats in a class on an aircraft—and this number is not visible to the booking process, hence there may be several threads which obtain prices above the bulk file specified maximum.

The thread therefore at 1937 tries to find a seat in the class specified in the bulk file and the thread parameter file. If this attempt does not succeed, the parameters inherited from the bulk file may allow this traveller to upgrade to a higher-class seat at 1938 (for instance if the traveller is in the absolutely necessary medical team). If an upgrade is not permitted, the thread fails and is aborted at 1939, returning the reason for failure. If a seat is found at 1940, the cost is retrieved and compared with the company policy at 1941. A seat priced within company policy parameters succeeds and the seat is partially booked at 1944 (it is not confirmed or paid for until the process has been completed).

If the cost is above company policy, a demand at 1942 for an override on the policy expressed in the parameter file is made. The logic available may refuse the override at 1942 and again the thread aborts at 1943. If the override can be accepted for this traveller, the seat is booked at 1944.

Meanwhile the cloud system will be completing at least some of the threads with a successful partial booking, with the threads returning a result not necessarily in the order in which they were spawned.

Eventually, all of the originating threads for each traveller and the threads for each flight will have returned success/failure flags and will allow a decision on whether to tune the bulk file further because of some booking failures in the whole process or to run with the bulk file as it currently stands. In either case the incomplete bookings so far made (which have not yet been paid for) will be cancelled.

Tuning the bulk file for optimum results both financially and in terms of travel acceptable to the travellers may require several iterations of the booking process, and each time the resultant bookings will be cancelled. Even when a final successful run of incomplete bookings has been made, the incomplete bookings are cancelled to allow a final booking process in which the funds available from previously unused tickets within the organization can be utilized where available in the partial purchase of the new tickets. These will have been entered into the bulk file data but the credit available to the ticketing process will require a separate validation process at the ticketer before use and is preferably not done during the initial attempts to find a solution to the overall booking of the shift.

### Example 4

In this exemplary embodiment of the invention, the Group Booking (GB) application enables travel bookers to book flights for a large number of travellers simultaneously as described above. The abbreviation “GB” will be used throughout this example. The process utilises pre-defined and reusable criteria for the automatic allocation of the best available flight and fare combinations which are offered at the time of booking.

The application operates with a large, and expandable, number of air providers and global distribution systems (GDS). The application also allows for external integration by both consuming and exposing application programming interfaces (API).

Once the bulk file is uploaded and the merged prioritised set of rules is generated in accordance with the organisation's policies, the merged prioritised set of rules can be used by the booking tool to identify suitable flights and to start the booking process in accordance with this rules. An example is shown below under the heading prioritisation order—though it should be noted that this can differ from organisation to organisation. Most will prioritise arrival time over cost per fare or cost per collocation of bookings, though some organisations may require a different priority order.

The dynamic assessment and allocation of available flights and fares requires constant interaction between the provider's inventory applications and the GB application, as fare inventory is a dynamic factor, adjusted by the simultaneous purchasing actions of multiple 3^{rd} parties. In order to display to the travel booker, an expected fare allocation for each requested traveller with some certainty, the system preferably uses a process of making temporary bookings and then re-requesting availability.

The GB application integrates with the Applicant's existing Serko Online™ traveller profile subsystem. An API and profile synchronisation service allows for travellers to be synchronised between Serko Online™ and 3^{rd} party applications. This allows travel bookers to use the GB application in order to make bookings for travellers configured within their own systems.

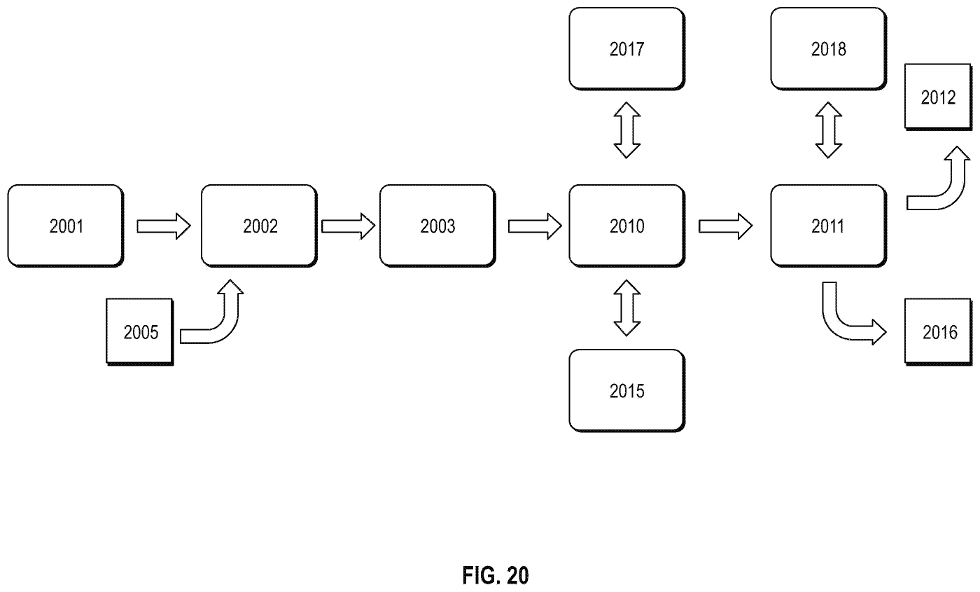

Process flow is shown schematically in FIG. 20 and will be discussed in more detail below.

Flight and Fare Allocation

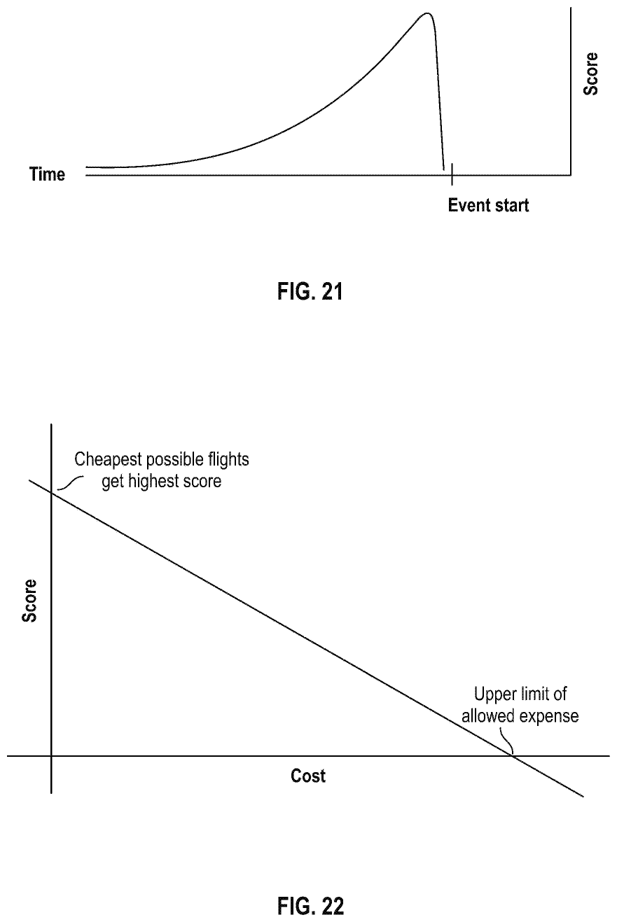

FIG. 21 shows a graph of a scoring system to illustrate the importance of locating a suitable flight as close as possible to the desired arrival time of a shift for the GB.

FIG. 22 shows a different graph illustrating the importance of cost and an upper limit on the cost of a fare.

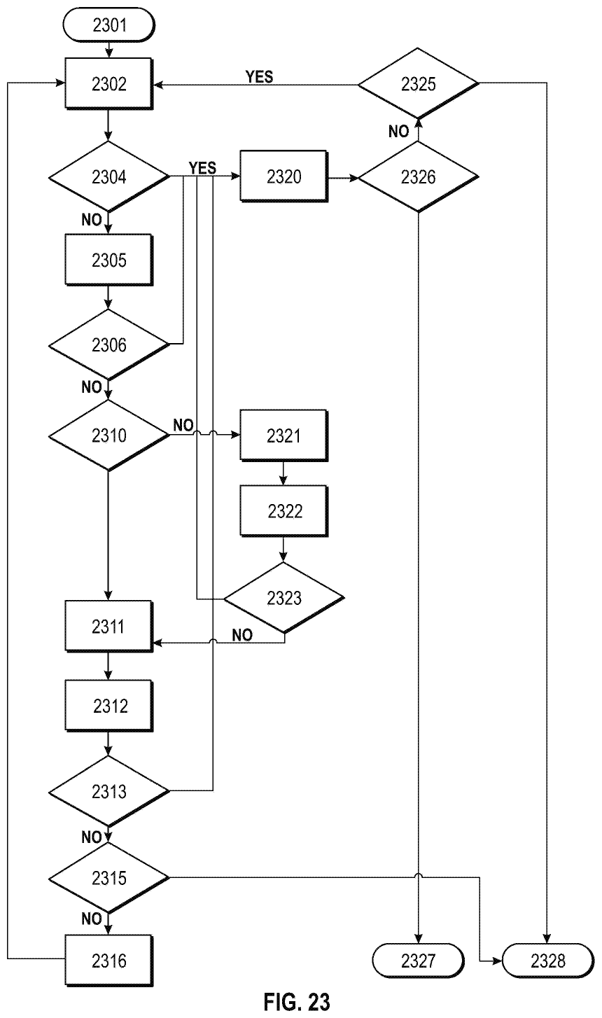

A simplified view of the flight and fare allocation is shown in FIG. 23 and is described in more detail below. This process is one of cycling through the list of requested traveller and booking combinations and allocating flights and fares according to the requested selection criteria.

The process begins by determining the flight which best meets the requested criteria and then selecting the preferred fare; with the fare preference either by ordering within a pre-configured list of fare classes or by lowest price. The preferred fare is then sold for as many travellers as possible. Once the preferred fare has been fully sold out then the entire availability result is re-evaluated and potentially a different flight is selected for the remaining travellers. This process is repeated as required.

A complication in the process of selling seats is that some providers expire sessions within a short timeframe. The execution of large numbers of availability requests is a time-consuming process, and therefore, even running multiple simultaneous requests, it is possible for availability information to expire prior to booking.

This complication has required the development of functionality which manages multiple asynchronous requests across multiple servers. In this, a trade-off between performance and server resources has to be managed also—the number of processes running can result in the application exceeding operating memory constraints causing system errors.

Flight Selection

The allocation of a flight for a particular traveller can be made statically within the import file, by specifying a preferred flight number directly, or dynamically by specifying a time and a condition to match. These time conditions are:
At
After
Before
Near

In this case the flight which best matches the entered criteria is selected for the traveller and displayed for evaluation on the review screen (if requested).

It is also possible in the import file to request “via” conditions; which specify which city or cities are preferred as stop over locations when the route requires them. This will influence the flights selected during the allocation process.

Prioritisation Order

The following is the criteria used when sorting flights, prior to selecting which flight to allocate. The list is in decreasing order of importance, i.e., number 1 on the list is most important:
1. Is within Policy
2. Is within policy specified Time Window requirements
3. Meets the requested Time Conditions
4. Meets Via Conditions (the requested connecting flights)
5. If logical flights is enabled: Number of Stops (to force directs to show first)
6. Minimum Price (or Base Fare if Price is invalid/empty/null)
7. Variance from requested Times
8. Total Journey Time
9. Line Reference (in the GDS response; in other words, use the ranking which is requested when making the GDS availability call)

Fare Selection

Fares are selected according to a configured criteria, either a prioritised list of preferred fare categories or by lowest price.

In addition, a requested baggage allowance can be specified in the import file against each traveller and the fare which offers the baggage request will be selected.

Unused Ticket Allocation

Travel management companies are able to accrue ‘unused’ tickets—i.e., purchased airline tickets which for some reason were not actually used by a traveller. These unused tickets can then be used as partial purchase of new tickets, given a range of usage and applicability constraints.

Given that these unused tickets represent a considerable financial investment for some clients, the GB application is required to be able to allocate and make use of tickets when making purchases. As such, the applicability constraints must be considered.

Unused tickets can be allocated in several different ways:
A travel booker is able to add actual unused ticket number to the import file against a specific booking. In the validation phase of the process, the unused ticket number is checked for validity and a message displayed to the travel booker if the credit is unable to be used. The unused ticket credit is also validated for applicability prior to making a booking request, with no warning given to the booker if the unused ticket is unable to be applied at this stage of the process.
During the review stage, an unused tickets link is added to each booking (though only if credits are available to that traveller) which allows the travel booker to select an unused ticket credit for that specific booking.
In this scenario the list of available unused ticket credits is dynamically created each time to ensure that when a credit is selected for a particular booking, it should not be displayed as an option when the unused tickets link is used for another booking where that credit may have been available for redemption.
GB checks for available unused ticket credits during the review of bookings to be made and automatically applies credits. Preferably these are selected by highest price or by soonest expiry of the unused ticket.

Technical Complexities

Multi-Threading

The asynchronous operation of processes is inherent in modern computing architecture and is widely used within the Serko Online™ system in order to provide the required performance characteristics.

The GB application runs multiple requests asynchronously and allows for the dynamic reallocation of availability made by the airline booking systems while determining available numbers of inventory on offer.

A particular physical seat in an aircraft can be offered for sale under multiple fare categories; and when one booking purchases one of those fares, the number of fares available for purchase in each affected fare category is decremented.

As a mitigation for the lack of dynamically updated availability numbers from the supplying systems, the GB application is purchasing the required number of seats under the determined fare categories to validate availability before releasing the inventory and later making bookings—with some degree of confidence of booking succeeding.

Without this pre-purchasing of seats, the airline booking systems often return a failure to book or purchase for a number of the travellers and/or bookings. This is problematic when trying to book large numbers of travellers.

After retrieving the list of bookings to be processed, these are prioritised before processing. This is to ensure that the bookings ranked with the highest priority are given the greatest likelihood of successfully completing a booking with the preferred selections.

Bookings are marshalled across the multiple asynchronously run threads in order to manage memory and resource usage on the servers, to maximise throughput and to refresh any connected user interfaces.

Multi-Server

Server resources are managed centrally using the Serko Online™ administrative interface. Each resource is an individually instantiated windows service which is monitored for performance and fault-tolerance.

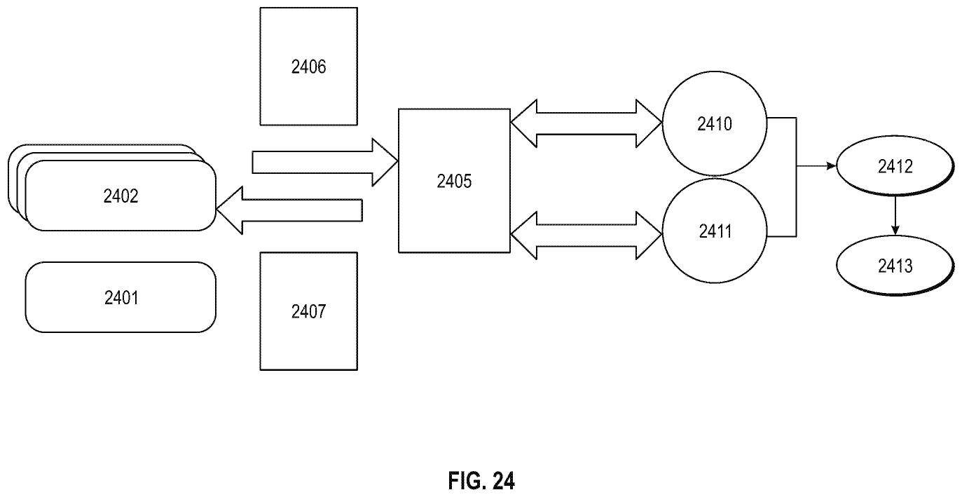

An overview of this architecture is shown in FIG. 24 (described below), in which two GB servers are demonstrated. Each of these interact with the GB application codebase which in turn interacts with the instance of Serko Online™.

Server resources are dynamically scaled, and the GB application employs a degree of load balancing to ensure maximum throughput across all server resources. State is stored with the database layer of the application and used in order to co-ordinate across the various processing instances.

Polling, Asynchronicity and UI Display

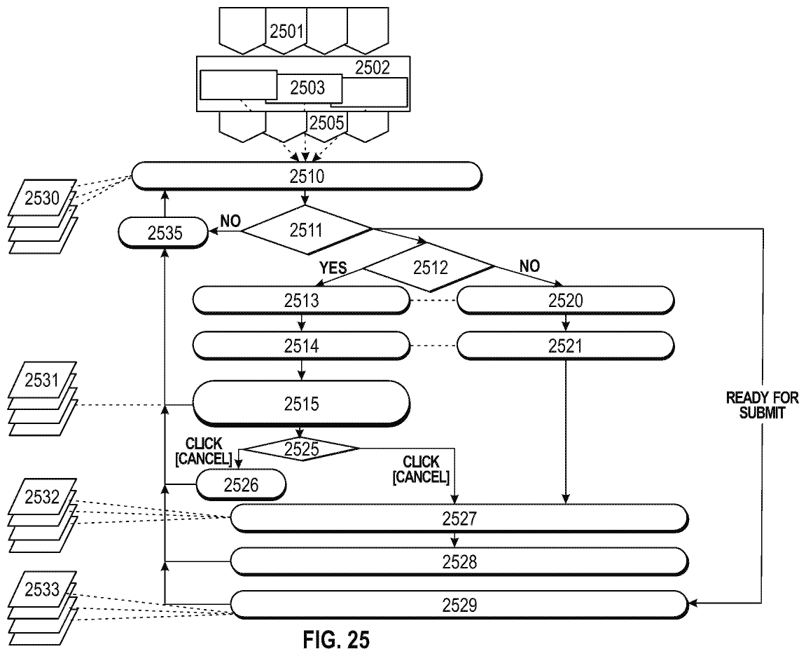

An alternative view of the process flow is shown in FIG. 25 (described below), which outlines the user-centric view of the process flow. This highlights the asynchronous nature of the operation and the separation between processing and user interface (UI) refreshing.

When beginning the group booking process, the user has an option to review the availability results prior to booking, and this is indicated in the process decision tree within the diagram. The review process introduces much complexity in the booking algorithm, particularly in trying to present an accurate prediction of final results to the booker.

Also, at the review stage, the booker has the option to block booking, which can then be re-submitted for booking at the summary stage.

Cost Centres

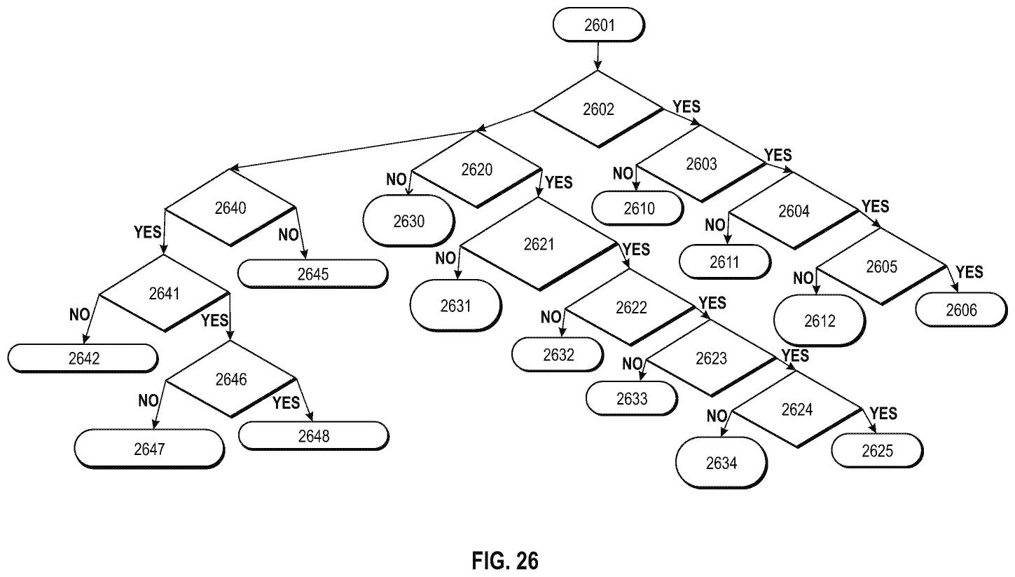

Most organisations will have rules requiring allocation of travel costs to particular cost centres. FIG. 26 shows how such allocations can be managed by the booking tool.

FIG. 20 shows a process flow from the initial setup at 2001 through to a group booking and a notification to each member of the group, and a summary of the total group booking at 2016.

Box 2001 indicates the initial setup with the cost centre, authorise, policy, importation of the customers filename, the customers fields, and the notification details.

The next step is box 2002 which corrects import issues, examples are:
invalid cities
Traveller details
dates
times

This comes from the traveller data file which is uploaded to step 2002 from the customer at 2005.

Box 2003 checks the traveller details, the frequent flyer numbers, and the cost centre of any guest travellers.

Box 2010 checks the availability of different flights, and then selects the flight and fares using step booking logic.

At step 2017 the system allows for the change of flight/travel date for travellers and the ability to block any flights the customer does not want booked. At step 2015 it is possible to review/assign unused tickets. At step 2011 the results are displayed on screen and step 2018 allows for the resubmission of any failed bookings. When booking is completed, individual travellers are notified, typically via their smart phone, and the group booking results are exported at 2016 to the customer.

FIG. 23 shows flight and fare allocation starting at 2301 for each individual booking. Then, a flight is selected which fits the criteria for the time window (between departure and arrival times) at 2302.

Step 2304 checks to see if the flight has been found, and if NO, the process moves on to 2305 when another flight is selected, and then 2306 checking to see if the flight has been found. If the result is NO the process moves to step 2310 where both the arrival and departure times are checked.

If these arrival and departure times are too limiting, the times can be dropped at 2311, and the process repeated at 2312 to select a flight and 2313 to check if the flight has been found. If no flight is found that it is checked to see if the request is already using “out of policy”, and if it is then the system raises an error at 2328. But if not, then the system moves on to 2316 and it is then allowed to include “out of policy flights” and the process repeated at step 2302.

If the flight was found at steps 2304, or 2306, or 2313, the system moves on to “select fare” at 2320 and if the fare is found at step 2326, it moves to 2327 where the fare is saved. If the fare was not found at 2326 the process moves to box 2325, and more flights are investigated, and the process recommences at 2302.

If at 2310 the arrival time provides an undue limitation on possible flights, the arrival time can be dropped at step 2321, and a flight can be selected at 2322. If a suitable flight is found the process moves to step 2320 and repeats the process for the appropriate fare. If at 2323 a suitable flight is not found, then the process moves to step 2311 and both the arrival and the departure times are dropped, and it moves through the process from 2312 to 2316, as described above.

FIG. 24 shows an architectural overview in which a travel booker represented by 2401 uses the web application at 2402 and interacts with an SQL data store at 2405. 2406 shows requested booking details and 2407 shows review and results. The SQL data store 2405 communicates with one or more group booking servers 2410 and 2411, and these then output to a group booking application at 2412, which communicates with Serko Online™ at 2413.

FIG. 25 shows a user centric view of process flow.

Group booking requests are submitted to Serko Online™ in xlsx import files.

The import files are validated and converted into grouped booking records marked “Ready for availability” in the SQL database by Serko Online™. The Serko web servers are load balanced so any server can process each import file. (Three Web servers are shown in FIG. 25, although additional servers can be added as needed, and the drawing is representative only of the process and not the number of Web servers).

Each Web server runs a Group Booking service (GB service) they can create bookings from these booking records. Each GB service can only process one set of “ready” booking records at a time.

The webpage runs a regular request to check the status of current bookings (every 10 seconds). If the status of any booking is changed then the page refreshed.

2501 shows a set of different group booking records in xlsx format. These group booking requests are sent to Serko online at 2502, using the load balanced servers 2503 and the booking records 2505 are sent via the SQL database to the GB services at 2510. All the GB services continuously poll the database every 60 seconds for any group booking records marked as “ready”.

Each GB service can process one set of “ready” bookings at a time. The “ready” bookings are polled at 2511, and if the booking is marked as “ready” the process moves on to 2512. If the booking is not marked as ready at 2511 it moves to 2535 and is polled again in 60 seconds.

2530 represents a set of group booking records which are “ready for availability”. 2531 shows a set of bookings most of which are in process. 2532 represents a set of bookings most of which are “ready to submit”, and 2533 represents a set of bookings which are now marked as completed.

Turning now to step 2512 the bookings which are “ready for availability” are checked to see if the user ticked “review booking details” option during set up. If the user checked this option the process moves on to 2513 which blocks the user from submitting another group booking until all of the users current booking records are complete. From there 2514 updates the booking records status to “getting availability”. The system then searches for flights/allocates flights to booking records. At 2515 the system updates booking records status to “availability complete” or “error”.

The service resumes polling for “ready” bookings (including any bookings for “availability failed” and the retry count has not yet been reached). If all of those are complete the system moves on to 2525 which the user can complete the review. If the user clicks “cancel” the system moves to 2526 and the booking records are discarded, and the process starts again. If the user clicks “next” the system moves on to 2527 and it updates multiple like booking records that fit multipax criteria to “ready for multipax”. It creates single pax bookings from the multipax records. It updates all booking records status to “ready to submit”. At 2528 the service resumes polling of the database every 60 seconds for group booking bookings records in a “ready” state. At 2529 the system updates all booking records to “processing”. It submits bookings. It updates all bookings to “completed” or “error”. Bookings that fail to submit will be retried on next service pass until the retry count is reached.

FIG. 26 is a cost centre flow chart. Starting at 2601 a customer submits a booking request. At 2602 it checks the value of “use travellers cost centre”. If the result is true it moves on to 2603 which checks if the import contains bookings that have “booking alt cost code”. If that is true it moves to 2604 and checks the individual booking to see if it contains “booking alt cost code”. If that is true it moves to 2605 and checks to see if the “booking alt cost code” exists in the corporate hierarchy. If that is true it moves to 2606 and creates the booking using the “booking alt cost code” cost centre. If the result of the query at 2603 is false, i.e., checking if the import contains bookings that have “booking alt cost code”, it defaults to 2610 and all bookings are created using each traveller's own to full cost centre. If the query at 2604 returns a NO, it moves to 2611 and this also creates bookings using the “travellers own default travel” cost centre. However, if the query at 2605 is false, it creates a message at 2612 showing “error 403—forbidden booking fails, and it is placed in the failed booking queue—the message being—“alt cost centre is invalid. Booking not created.” If the query at 2602 “what is the value of use travellers cost centre” is false, the system moves to 2620 this allows the customer to enter a cost centre code and confirm it is in the booker's corporate hierarchy. However, if that is false, 2621 checks to see if the booker has access to a cost centre code according to their default admin cost centre. If the result of that query is false, it creates another error 403 and no booking is processed.

However, if the result of 2621 is correct then it checks to see if the import contains bookings that have “booking alt cost code” at 2622.

If the query at 2620 is false it moves to 2630 which sends an error 403 and the booking is not created. If the query at 2622 results in a yes then the system moves on to 2623 and again it checks if the individual booking contains “booking alt cost code”. If 2623 returns a yes then that checks at 2624 to see if the “booking alt cost code” exists in the corporate hierarchy. If it does it moves on to 2625 and creates the booking using that “booking alt cost code” cost centre. But if but if it does not, it moves on to 2634 returns another error 403 and no booking is created.

2620 can lead to a separate process at 2640, if the cost centre code is not populated. 2640 checks again to see if the import contains bookings that have “booking alt cost code”. If the result of that query is yes then the process moves to 2641, and individual bookings are checked to see if they contain “booking alt cost code”. If the result of that query is NO 2642 allows the system to create a booking in the bookers “default admin cost centre”. If the result of the query at 2641 is yes it again checks at 2646 to see if “booking alt cost code” exists in the corporate hierarchy. If the result of that query is a yes that moves to 2648 and creates booking using the “booking alt cost code cost” centre. However, if the answer to that query at 2646 is NO then it generates another error 403 and no booking is created at 2647.

Variations

The booking process may book an individual's trip complete with any transfers, overnight stops, meals etc., thus completely automating the booking process.

The description relates to interfacing with a generic booking system but can also interface with the Amadeus commercial booking system.

The term “crew movement” is synonymous with many other terms for the bulk travel of individuals to a common destination whether together or individually.

### Advantages

Real-World example: Prior to this invention, an Australian company completed a rotational shift every 3 weeks for approximately 360-380 workers in which part of the travel was to be by aircraft. The only method prior to this invention was to book the rotation using a travel agency to undertake the attempt to ‘move’ a rotational group to a destination manually. The delays with attempting to secure a manual transportation booking meant additional days and high costs for the corporate to amass the collective workforce.

It took on average 7 days for a team of 6 travel agency consultants to complete all worker bookings at a much higher cost due to reduced availability of the supply from day 1 of the booking process compared to day 7 costs. The later the booking is made the more expensive it is, and the risk of the flight being full before the booking is completed.

This invention allowed the same size rotation to be earmarked, flight availability to be assessed in under one minute, reviewed and booked within approximately a 40-45-minute automated process. Thus, benefitting the corporation and travel agency, time, cost, on-time performance, and outcome of the crew movement.

Whilst this invention provides a group booking process, usually for a known group of workers (i.e., a crew) or a team, it is also able to handle the booking for a ‘Guest Traveller’ which is a traveller without a stored Profile—the Guest Traveller will typically be a one-off contractor. The ability to handle disparate, Custom or no relationship guests is unique as previously all travellers required a profile. This allows a mining business to contract individuals with specialized roles to support the Mining shift team. The specialists would also be validated for their Health & Safety requirements.

### INDUSTRIAL APPLICABILITY

The invention relates to a semi-automated booking system for a group movement to a destination and a process of providing data to the booking system and booking travel or accommodation with the aid of an input file incorporating both policies of the organization and persona data for each traveller, allowing the use of a multi-threaded approach to bookings and so giving a decreased work time for the booking process while allowing control of the overall booking process. The process therefore results in a reduction in manual costs/time and is industrially applicable.

1. A crew movement computer system for automated bulk booking of travel for a plurality of individuals associated with a corporate body, the system comprising:
a server, in communication with an information storage system having stored thereon first information comprising details of corporate body travel rules, second information comprising details of the individuals, and third information comprising travel policies of the individuals,
the server being remote from a computer system of the corporate body and configured to receive communications over the Internet from the computer system of the corporate body,
the server further configured to communicate with travel and accommodation providers,
the server having software recorded in a memory thereof that, upon execution by the server, causes the server to operate:
as a bulk file parser that:
reads and operates upon a bulk file uploaded to the server, the bulk file containing essential information, including a date and a time of travel associated with the crew movement, for booking a crew movement for travel of at least a number of the individuals associated with the corporate body to a destination, said bulk file comprising a list of the number of the individuals as travellers in the crew movement,
the bulk file being segregated by predetermined categories of travel information, including i) details of each one of said travellers, ii) additional travel policies of each one of said travellers, and iii) additional travel policy properties of the corporate body, at least some of the predetermined categories of travel information being mandatory information necessary to create a booking,
the bulk file parser configured to parse the bulk file according to the predetermined categories of travel information to determine
a) for each traveller, whether said traveller has corresponding details and travel policies stored in the first and second information stored on the information storage system, the server being configured to indicate any travellers whose details and travel policies are not so stored, and
b) whether all said mandatory information is present, and, where mandatory information is missing, cause the server to take remedial action including one or more of querying the information storage system for the missing information, requesting input of the missing information and inputting a suggestion for the missing information,
the server further configured so that if, in relation to a traveller of said travellers, the server receives as input details, travel policies, or other mandatory information that is not stored in the information storage system, the server stores said details, travel policies, or other mandatory information in the information storage system,
as a rule merger that merges, for each traveller of said travellers:
(a) the corporate body travel rules stored in the information storage system as the first information,
(b) the date and the time of travel associated with the crew movement indicated in the bulk file,
(c) the additional travel policy properties of the corporate body in the bulk file,
(d) the details, stored in the information storage system, of each of the travellers in the crew movement,
(e) one or more travel policies associated with the traveller stored in the third information on the information storage system, and
(f) the additional travel policies associated with of the traveller stored in the bulk file,
said merging occurring in a specified manner to produce a merged set of rules including the number of travellers,
and as a booking tool for booking travel for each of the travellers in the crew movement,
if a flight is specified in the bulk file, then the booking tool checks if the flight exists on the day/time specified and if it does, then moving to the booking step;
or if the specified flight does not exist on the day/time specified, or if no flight is specified in the bulk file, then retrieving the date/time window at the destination from the merged set of rules, then the booking tool conducts a search for flights which correspond to the date/time window, selecting the flight most closely matching the date/time window and moving to a booking step;
at the booking step the booking tool configured to communicate with booking systems of the travel and accommodation providers to make incomplete travel bookings for each of the travellers to the destination in compliance with the merged set of rules, and checking that that the collection of incomplete bookings complies with the merged set of rules and
if so, it then issues the bookings,
or, if the collection of incomplete bookings does not comply with the merged set of rules then cancelling the incomplete bookings and selecting another flight and repeating the booking step.

2. A crew movement computer system for automated bulk booking of travel for a plurality of individuals associated with a corporate body, the system comprising:
a server, in communication with an information storage system having stored thereon first information comprising details of corporate body travel rules, second information comprising details of the individuals, and third information comprising travel policies of the individuals,
the server being remote from a computer system of the corporate body and configured to receive communications over the Internet from the computer system of the corporate body,
the server further configured to communicate with travel and accommodation providers,
the server having software recorded in a memory thereof that, upon execution by the server, causes the server to operate:
as a bulk file parser that:
reads and operates upon a bulk file uploaded to the server, the bulk file containing essential information, including a date and a time of travel associated with the crew movement, for booking a crew movement for travel of at least a number of the individuals associated with the corporate body to a destination, said bulk file comprising a list of the number of the individuals as travellers in the crew movement,
the bulk file being segregated by predetermined categories of travel information, including i) details of each one of said travellers, ii) additional travel policies of each one of said travellers, and iii) additional travel policy properties of the corporate body, at least some of the predetermined categories of travel information being mandatory information necessary to create a booking,
the bulk file parser is configured to parse the bulk file according to the predetermined categories of travel information to determine
a) for each traveller, whether said traveller has corresponding details and travel policies stored in the first and second information stored on the information storage system, the server being is configured to indicate any travellers whose details and travel policies are not so stored, and
b) whether all said mandatory information is present, and, where mandatory information is missing, cause the server to take remedial action including one or more of querying the information storage system for the missing information, requesting input of the missing information and inputting a suggestion for the missing information,
the server further configured so that if, in relation to a traveller of said travellers, the server receives as input details, travel policies, or other mandatory information that is not stored in the information storage system, the server stores said details, travel policies, or other mandatory information in the information storage system;
as a rule merger that merges, for each traveller of said travellers:
(a) the corporate body travel rules stored in the information storage system as the first information,
(b) the date and the time of travel associated with the crew movement indicated in the bulk file,
(c) the additional travel policy properties of the corporate body in the bulk file,
(d) the details, stored in the information storage system, of each of the travellers in the crew movement,
(e) one or more travel policies associated with the traveller stored in the third information on the information storage system, and
(f) the additional travel policies associated with of the traveller stored in the bulk file,
said merging occurring in a specified manner to produce a merged set of rules including the number of travellers,
and as a booking tool for booking travel for each of the travellers in the crew movement,
wherein if a flight is specified in the bulk file, then the booking tool checks if the flight exists on the day/time specified and if it does, then moving to the booking step;
or if the specified flight does not exist on the day/time specified, or if no flight is specified in the bulk file, then retrieving the date/time window at the destination from the merged set of rules, then the booking tool conducts a search for flights which correspond to the date/time window, selecting the flight most closely matching the date/time window and moving to a booking step;
at the booking step the booking tool configured to communicate with booking systems of the travel and accommodation providers to use said communication to make incomplete travel bookings for each of the travellers to the destination in compliance with the merged set of rules, and
checking that that the collection of incomplete bookings has reached the total number of travellers and if so, it then issues the bookings,
or, if the collection of incomplete bookings has not reached the total number of travellers when all available bookings on that flight have been exhausted, then cancelling the incomplete bookings and selecting another flight and repeating the booking step.

3. A crew movement computer system for automated bulk booking of travel for a plurality of individuals associated with a corporate body, the system comprising:
a server, in communication with an information storage system having stored thereon first information comprising details of corporate body travel rules, second information comprising details of the individuals, and third information comprising travel policies of the individuals,
the server being remote from a computer system of the corporate body and configured to receive communications over the Internet from the computer system of the corporate body,
the server further configured to communicate with travel and accommodation providers,
the server having software recorded in a memory thereof that, upon execution by the server, causes the server to operate:
as a bulk file parser that:
reads and operates upon a bulk file uploaded to the server,
the bulk file containing essential information, including a date and a time of travel associated with the crew movement, for booking a crew movement for travel of at least a portion of the individuals associated with the corporate body to a destination, said bulk file comprising a list of the at least a portion of the individuals as travellers in the crew movement,
the bulk file being segregated by predetermined categories of travel information, including i) details of each one of said travellers, ii) additional travel policies of each one of said travellers, and iii) additional travel policy properties of the corporate body, at least some of the predetermined categories of travel information being mandatory information necessary to create a booking,
the bulk file parser configured to parse the bulk file according to the predetermined categories of travel information to determine
a) for each traveller, whether said traveller has corresponding details and travel policies stored in the first and second information stored on the information storage system, the server being configured to indicate any travellers whose details and travel policies are not so stored, and
b) whether all said mandatory information is present, and, where mandatory information is missing, cause the server to take remedial action including one or more of querying the information storage system for the missing information, requesting input of the missing information, and inputting a suggestion for the missing information,
the server further configured so that if, in relation to a traveller of said travellers, the server receives input from an operator including details, travel policies, or other mandatory information that is not stored in the information storage system, the server stores said details, travel policies, or other mandatory information in the information storage system;
as a rule merger that merges, for each traveller of said travellers:
(a) the corporate body travel rules stored in the information storage system as the first information,
(b) the date and the time of travel associated with the crew movement indicated in the bulk file, (c) the additional travel policy properties of the corporate body in the bulk file,
(d) the details, stored in the information storage system, of each of the travellers in the crew movement,
(e) one or more travel policies associated with the traveller stored in the third information on the information storage system, and
(f) the additional travel policies associated with the traveller stored in the bulk file,
said merging occurring in a specified manner to produce a merged set of rules, wherein the specified manner of merging the respective policies comprises resolving conflicts between the policies, wherein:
the additional travel policy properties of the corporate body in the bulk file override the corporate body travel rules of the first information stored on the information storage system,
the additional travel policies of the travellers in the bulk file override the travel policies of the travellers in the first information stored on the information storage system, and
the corporate body travel rules of the first information and the additional travel policy properties of the corporate body override the travel policies of the third information and the additional travel policies of the travellers in the bulk file;
and as a booking tool for booking travel for each of the travellers in the crew movement,
wherein the booking tool is configured to establish communication with booking systems of the travel and accommodation providers, to use said communication to create incomplete bookings for each of the travellers to the destination in accordance with the merged set of rules, and to check that the totality of the incomplete bookings has reached the total number of travellers and if so, it communicates with the booking systems of the travel and accommodation providers to use said communication to convert the incomplete bookings into issued bookings,
or, if the collection of incomplete bookings has not reached the total number of travellers when all available bookings on that flight have been exhausted, then it communicates with the booking systems of the travel and accommodation providers to use said communication to cancel the incomplete bookings and selecting another flight and repeating the booking step,
wherein the booking tool is configured so that:
if a flight is specified in the bulk file, the booking tool uses said communication to confirm whether the specified flight exists on a day/time included in the bulk file for the flight, and when the flight is confirmed to exist for the flight on the day/time specified in the bulk file then the booking tool selects the specified flight as the selected flight, and
if the flight specified in the bulk file does not exist on the day/time specified in the bulk file, or if no flight is specified in the bulk file, the booking tool retrieves a date/time window for arrival at the destination from the merged set of rules, uses said communication to search for alternate flights which correspond to the date/time window, and selects an alternate flight as the selected flight from said alternate flights that most closely matches the date/time window,
and wherein the booking tool is further configured to:
use said communication to check whether available fare levels for the selected flight is in accordance with the merged set of rules, and if the available fare levels for the selected flight are not in accordance with the merged set of rules, the booking system uses said communication to iteratively check one or more next closest matching flights until the travel is booked for all the travellers such that all flights of the travel for the travellers are in accordance with the merged set of rules.

4. The crew movement computer system as claimed in claim 3, wherein the booking tool issues emails to each of the travellers successfully booked via said communication.

5. The crew movement computer system as claimed in claim 4, wherein said additional travel policy properties of the corporate body relate to travel-specific policy properties applying to this particular crew movement.

6. The crew movement computer system as claimed in claim 5, wherein said additional travel policy properties of the corporate body relate to a particular traveller being granted elevated travel or accommodation privileges.

7. The crew movement computer system as claimed in claim 3,
wherein at least one of said third information and said additional travel policies of at least one traveller of said travellers is a priority-rated travel policy, and
wherein said rule merger, for said at least one traveller, overrides the corporate body travel rules of the first information and the additional travel policy properties of the corporate body in favor of the priority-rated travel policy.

8. A computer implemented method of automated bulk travel booking for a plurality of individuals associated with an organization, the method comprising:
providing a booking system comprising computer hardware and software stored on a non-transient data storage medium of the computer hardware and executable by a processor of the computer hardware;
storing in the booking system, first stored information relating to the organization's travel policies;
storing in the booking system, second stored information relating to details and travel policies of said individuals; and
uploading to the booking system and storing, in the booking system, a bulk file relating to a travel event for the organization whereby at least a portion of the individuals are indicated as travellers for whom travel is to be arranged for the travel event, the bulk file being segregated by predetermined categories of mandatory information,
said mandatory information including details of each one of said travellers, a destination of each traveller, additional travel policies of the organization, and the date and time window for arrival at the destination;
the bulk file optionally specifying flight details;
generating, via the booking system operating under direction of the software, a group movement corresponding to the travel event of the travellers to the destination merging the organization travel policies, the details and travel policies of the travellers, and said additional travel policies of the organization, to generate and store a merged prioritized set of rules;
if a flight is specified in the bulk file, then the booking system checks if the flight exists on the day/time specified and if it does, then moving to the booking step;
or if the specified flight does not exist on the day/time specified, or if no flight is specified in the bulk file, then retrieving the date/time window at the destination from the merged prioritized set of rules, then the booking system conducts a search for flights which correspond to the date/time window, selecting the flight most closely matching the date/time window and moving to the booking step;
at the booking step the booking system checks that the selected flight and available fare levels accords with the organization's polices:
if so, the booking system creates individual bookings in accordance with the merged prioritized set of rules by spawning a number of booking threads and connecting to a Global Distribution System (GDS) such that a travel request for each individual traveller is presented to a GDS booking system as a process thread for booking, and multiple process threads are presented in parallel,
if not, the booking system proceeds to the next closest matching flight and repeats the check on the organization's policies and repeats the booking process.

9. The method of booking travel as claimed in claim 8, wherein the search for flights is achieved by spawning a number of search threads to query the availability of different flights or other travel stages from one or more travel providers.

10. The method of booking travel as claimed in claim 8, wherein the available flights are compared with the merged prioritized set of rules to assess if each flight is within policy; and
meets the and the date and time window for arrival at the destination.

11. The method of booking travel as claimed in claim 8, wherein the prioritized set of rules comprises:
what flight should be taken,
what fare levels are allowable,
what should be booked or marked as waitlisted,
whether interconnecting flights using an overnight stop are allowable,
what level of accommodation is allowed at an overnight stop,
what expenditure allowance is set,
whether minimum fare levels can be overridden and to what extent,
what arranged fares are available, and
what charter helicopter flights may be available from an airport destination.

12. The method of booking travel as claimed in claim 8, wherein the booking system stores categories of what information is mandatory, and checks for data completeness by:
retrieving, from the first stored information, the organization travel policies for said group movement;
parsing the bulk file uploaded to the booking system according to the predetermined categories of mandatory information to determine
a) for each traveller, whether said traveller is an individual whose details and travel policies are stored in the second stored information, and generating an indication for any travellers whose details and travel policies are not so stored, and
b) whether all mandatory information is present;
if all mandatory information is present in the bulk file, retrieving the mandatory information including the details and travel policies of each one of the travellers, and the additional travel policies of the organization;
if mandatory information is missing from the bulk file, taking remedial action including one or more of:
querying at least one of the first and second stored information for the missing information,
requesting input of the missing information, or
inputting a suggestion for the missing information;
retrieving any further details and travel policies of the travellers from the first and/or second stored information.

13. The method of booking travel as claimed in claim 1, wherein the method also includes defining a booking window in which all of the bookings need to be completed;
using the merged prioritized set of rules, individually booking travel for each one of the travellers to the destination in compliance with the merged set of rules in order to complete all of the bookings within the defined time window; and on successful completion issuing the bookings and outputting the bookings to the organization and/or the individuals.

14. A computer system for automated bulk travel booking for a plurality of individuals associated with an organization, the system comprising:
a server, in communication with an information storage system having stored thereon details of organization travel rules, details of the individuals, and travel policies of the individuals,
the server having a non-transitory computer-readable data storage with software stored therein, the software, upon execution by the server, configured to cause the server to operate:
as a bulk file parser that reads and operates upon a bulk file uploaded to the server of the booking system,
the bulk file relating to a travel event defining a date/time window for arrival of the plurality of individuals at a destination, whereby at least a portion of the individuals are indicated as travellers for travel to a destination, the bulk file being segregated by predetermined categories of mandatory information regarding each one of said travellers sufficient to create a booking, and additional travel policy properties of the organization;
as a rule merger that merges the organization travel rules stored in the information storage system and the additional travel policy properties of the organization in the bulk file, said merging occurring to generate and store a merged set of prioritized rules; and
a search tool to locate one or more flights that correspond to the date/time window, then to select a flight most closely matching the date/time window;
a checking tool to check that the flight and available fare levels accords with the organisation's polices;
as a booking tool for booking travel for each one of said travellers,
wherein the booking tool is configured to book travel for each one of the travellers to the destination in accordance with the merged set of rules and is configured on successful completion to output the bookings to the organization and/or to each of the individuals.

15. A computer system for automated bulk travel booking for a plurality of individuals associated with an organization, as claimed in claim 14, wherein the bulk file parser is configured to parse the bulk file according to the predetermined categories of mandatory information to determine:
a) for each traveller, whether said traveller is an individual whose details and travel policies are stored in the information storage system, wherein the server is configured to indicate any travellers whose details and travel policies are not so stored, and
b) whether all mandatory information is present,
and, where mandatory information is missing, cause the server to take remedial action including one or more of querying the information storage system for:
the missing information,
requesting input of the missing information, or
inputting a suggestion for the missing information.

16. A computer system for automated bulk travel booking for a plurality of individuals associated with an organization, as claimed in claim 15, wherein the booking system is configured to output the bookings by performing at least one of:
generating at least one of an e-mail or downloadable document listing all the bookings for the travellers, and
generating separate messages or e-mails to each traveller of the travellers with information of booking details of the traveller.

17. A computer system for automated bulk travel booking for a plurality of individuals associated with an organization, as claimed in claim 16, wherein the rule merge overrides one or more of the organization travel rules with one or more of the additional travel policy properties of the organization.

18. A computer implemented method of automated bulk travel booking for a plurality of individuals associated with an organization, the method comprising:
providing a booking system, comprising computer hardware and software stored on a non-transient data storage medium of the computer hardware and executable by a processor of the computer hardware;
storing, in the booking system, first stored information relating to organization travel policies;
storing, in the booking system, second stored information relating to details and travel policies of said individuals; and
uploading to the booking system and storing, in the booking system, a bulk file relating to a travel event for the organization, whereby at least a portion of the individuals are indicated as travellers to a destination common to all the travellers, the bulk file being segregated by predetermined categories of mandatory information;
said mandatory information including details of the organization booking the travel, additional organization travel policies, details of each one of the travellers, the common destination of the travellers, and a time and date at which the travellers are to be at the common destination;
generating, via the booking system operating under direction of the software, a crew movement corresponding to the travel event of the travellers to the common destination via sub-steps of:
retrieving, from the first stored information, the organization travel policies for said crew movement;
parsing the bulk file uploaded to the booking system according to the predetermined categories of mandatory information to determine
a) for each traveller, whether said traveller is an individual whose details and travel policies are stored in the second stored information, and generating an indication for any travellers whose details and travel policies are not so stored, and
b) whether all mandatory information is present;
if all mandatory information is present in the bulk file, retrieving the mandatory information including the details of the organization booking the travel, the details of the additional organization travel policies, the details of each one of the travellers, the common destination of the travellers, and the time and date at which the travellers are to be at the common destination;
if mandatory information is missing from the bulk file, taking remedial action including one or more of:
querying the stored information for the missing information, requesting input of the missing information, or
inputting a suggestion for the missing information;
retrieving any further details and travel policies of the travellers from the first and/or second stored information;
merging the organization travel policies, the details and travel policies of the travellers, and the additional organization travel policies to generate and store a merged set of rules;
using the merged set of rules, individually booking travel for each one of the travellers to the common destination in compliance with the merged set of rules; and
issuing the bookings and outputting the bookings,
wherein the booking system outputs the bookings by performing at least one of generating at least one of an e-mail or downloadable document listing all the bookings for the travellers, and
generating e-mails to each traveller of the travellers with information of booking details of the traveller.

19. The computer implemented travel booking method as claimed in claim 18, wherein the bulk file further includes details of a location the travellers are travelling from, and a time at which the travellers are to depart.

20. The computer implemented travel booking method as claimed in claim 19, wherein the bulk file further includes details of a required flight number.

21. The computer implemented travel booking method as claimed in claim 18, wherein the details of each one of the travellers includes each of a name, an address, and contact information, and also a profile of any special requirements applicable to the travel event.

22. The computer implemented travel booking method as claimed in claim 21, wherein the retrieval from the bulk file includes details of the location the travellers are travelling from and the time at which the travellers are to depart.

23. The computer implemented travel booking method as claimed in claim 22, wherein a required flight number is retrieved from the bulk file uploaded to the booking system.

24. The computer implemented travel booking method as claimed in claim 23, wherein each of the name, the address, and the contact information, as well as the profile of any special requirements applicable to the travel event, are retrieved from the bulk file uploaded to the booking system.

25. The computer implemented travel booking method as claimed in claim 18, wherein at least some of the individual bookings are conducted in parallel.

26. A method of bulk booking travel for a number of individuals for an organization, comprising: providing a booking computer system; storing in the booking computer system information relating to travel policies or rules of the organization; storing in the booking computer system information relating to profile details of individuals; creating and storing in the booking computer system a bulk file relating to the travel for an organization of a number of individuals to a destination, the bulk file including details of an arrival date/time window for the or each destination, the identity of each individual traveller, additional individual traveller travel details relating to this travel and additional travel policies or rule properties of the organization relating to this travel; creating within the booking computer system a crew movement relating to the travel of a number of individuals to the or each destination; the booking computer system retrieving from the stored information the organization travel policies or rules for the crew movement; the booking computer system retrieving the details and additional travel profiles of the individual travellers and travel policies of the organization from the bulk file; the booking computer system retrieving any further details and travel profiles, policies of the individual travellers from the stored information; the booking computer system merging the organization, individual traveller and bulk file policies or rules; the booking computer system connecting to a Global Distribution System (GDS) and identifying a flight or flights which most closely matches the arrival date/time window and then a travel request for each individual traveller is presented to a GDS booking system as a plurality of process threads for individually booking each traveller, and the plurality of process threads are processed in parallel,
individually checking for errors in the booking of each individual traveller to the destination, in accordance with the merged organization individual travel and bulk file policies or rules;
reviewing the collation of the individual bookings and, if the collation of bookings does not meet travel policies (including total cost) cancelling the totality forthwith and repeating the process,
if the collation of the individual bookings does meet travel policies
completing the collation of bookings and ticketing, the booking computer system thus booking the individual travel and issuing the bookings as ticketings.

27. A method as claimed in claim 26, wherein if the collation of the individual bookings does meet travel policies, carrying out the additional step of cancelling the totality forthwith and re-presenting the totality to the GDS booking system in a threaded manner for booking and ticketing the booking computer system thus booking the individual travel and issuing the bookings as ticketings.

28. A method as claimed in claim 27 wherein the travel request thread for each individual traveller originates from one of multiple cloud servers, each cloud server being capable of originating multiple threads.

29. A method as claimed in claim 28, wherein a cloud server thread relating to a travel request is capable of originating multiple other cloud server threads.

30. A method as claimed in claim 26, wherein when the collation of the individual bookings does not meet travel policies and have been cancelled, retrieving references to any unused ticketings currently held by the organization, originating in cancelled or other ticketings from previous travel, are compared with the flights now booked to see if they can be redeemed as part payment for some of the totality of bookings and if so the unused ticket is validated with the originator and applied during the ticketing process.

31. A method of booking travel as claimed in claim 26, wherein the bulk file includes at least some travel policy properties of at least some individuals, and wherein when the merged policies do not allow a booking to be made for an individual, the entry for the individual in the bulk file is marked as in error and referred for resolution before the booking process continues.

32. A method as claimed in claim 26, wherein the bulk file may contain conditional values relating to at least some of the time parameters specified for individual travel, the conditional values specifying the allowable variance from the time specified in the bulk file.

33. A travel booking computer system for bulk booking the travel of a number of individuals by an organization, comprising: a storage capable of storing details of the organization travel policy or rules and individual travel profiles; a bulk file parser capable of reading a bulk file including data from the organization; the bulk file including details of the required destination and desired date/time of arrival of the number of individuals, details of the individuals sufficient to create a booking, details of any additional individual travel policies and any additional corporate travel policies for the travel; a merger capable of merging the organization, individual traveller and bulk file policies, details and profiles; access to a travel booking provider; and a travel booker capable of: (a) individually checking with the travel booking provider the travel of each of the number of individuals to the destination in compliance with the merged organization, individual traveller and bulk file policies, details and profiles; and (b) booking the checked travel and issuing the booking if found to be in compliance with the merged organization, individual traveller and bulk file policies, details and profiles.

34. A travel booking system as claimed in claim 33 wherein the bulk file may contain conditional values relating to at least some of the time parameters specified for individual travel, the conditional values specifying the allowable variance from the time specified in the bulk file.
